(19) United States
(12) Patent Application Publication
(10) Pub. No.: US 2018/0139378 A1
(43) Pub. Date: May 17, 2018

(54) IMAGING DEVICE AND AUTOMATIC CONTROL SYSTEM

(71) Applicant: Kabushiki Kaisha Toshiba, Tokyo (JP)

(72) Inventors: Yusuke MORIUCHI, Tokyo (JP); Nao Mishima, Tokyo (JP)

(73) Assignee: Kabushiki Kaisha Toshiba, Tokyo (JP)

(21) Appl. No.: 15/693,404

(22) Filed: Aug. 31, 2017

(30) Foreign Application Priority Data
Nov. 11, 2016 (JP) 2016-220663

(51) Int. Cl. H04N 5/232; G06T 7/571

(52) U.S. Cl. CPC H04N 5/23212; G06T 7/571; H04N 5/23229

(57) ABSTRACT

According to one embodiment, an imaging device includes a first optical system configured to perform first image blurring and second image blurring to light from an object, an image capturing device configured to receive the light from the object through the first optical system and output a first image signal including first blur and a second image signal including second blur, and a data processor configured to generate distance information based on the first image signal and the second image signal.

### CROSS-REFERENCE TO RELATED APPLICATIONS

This application is based upon and claims the benefit of priority from Japanese Patent Application No. 2016-220663, filed Nov. 11, 2016, the entire contents of which are incorporated herein by reference.

### FIELD

Embodiments described herein relate generally to an imaging device and an automatic control system.

### BACKGROUND

A method using a stereo camera is known as a method of simultaneously acquiring a captured image and distance information. The same object is captured with two cameras, a parallax indicative of a correspondence of pixels having the same feature quantity is obtained by matching of two images, and a distance to an object is obtained from the parallax and the positional relationship between two cameras by the principle of triangulation. However, since this method requires two cameras and an interval between two cameras needs to be set to be long to obtain the distance with high precision, a device is upsized.

As a method of obtaining the distance with one camera, employment of the image plane phase difference AF technology as one of the autofocus (AF) technologies of camera has been considered. The image plane phase difference AF can determine a focusing status by obtaining a phase difference between two images obtained by receiving light transmitted through different areas of the lens, on the imaging surface of the image sensor.

However, if a repetition pattern is contained in the subject, the parallax can hardly be detected correctly and the distance cannot be obtained with good precision in the method based on matching. In addition, the AF technology can determine the focusing status but cannot obtain the distance.

### BRIEF DESCRIPTION OF THE DRAWINGS

FIG. 1 is a block diagram showing an example of a schematic configuration of a first embodiment.

FIG. 2 illustrates an example of an outline of a cross-sectional structure of an image sensor.

FIG. 3A illustrates an example of a pixel arrangement.

FIG. 3B illustrates an example of a color filter.

FIG. 4A illustrates an example of image formation in a front focus status.

FIG. 4B illustrates an example of image formation in an in-focus status.

FIG. 4C illustrates an example of image formation in a back focus status.

FIG. 5 illustrates examples of a shape of blur in image signals obtained from sub-pixels.

FIG. 6 illustrates examples of blur shape convolution kernels of an image signal.

FIG. 7 illustrates examples of blur shape correction of the image signal.

FIG. 8 is an example of a functional block diagram to obtain the distance estimation.

FIG. 9A is a diagram showing an example of operations for obtaining the distance.

FIG. 9B is a diagram showing an example of operations for obtaining the distance.

FIG. 10A is a diagram showing another example of operations for obtaining the distance.

FIG. 10B is a diagram showing another example of operations for obtaining the distance.

FIG. 11 is a flowchart showing an example of obtaining the distance.

FIG. 12 illustrates a first modified example of a pixel array of an image sensor according to the first embodiment.

FIG. 13 illustrates an example of an outline of a cross-sectional structure of the image sensor according to the first modified example.

FIG. 14 is a diagram showing an example of operations for obtaining the distance.

FIG. 15 is a flowchart showing an example of obtaining the distance.

FIG. 16 illustrates a second modified example of an optical system of an imaging device according to the first embodiment.

FIG. 17 illustrates an example of an optical system of an imaging device according to a second embodiment.

FIG. 18 illustrates an example of a pixel array.

FIG. 19 is an example of a functional block diagram to obtain the distance.

FIG. 20A illustrates an example of image formation in a front focus status.

FIG. 20B illustrates an example of image formation in an in-focus status.

FIG. 20C illustrates an example of image formation in a back focus status.

FIG. 21A is a diagram showing an example of operations for obtaining the distance.

FIG. 21B is a diagram showing an example of operations for obtaining the distance.

FIG. 21C is a diagram showing an example of operations for obtaining the distance.

FIG. 22A is a diagram showing another example of operations for obtaining the distance.

FIG. 22B is a diagram showing another example of operations for obtaining the distance.

FIG. 23 is a flowchart showing an example of obtaining the distance.

FIG. 24 is a diagram showing an example of combination of the images used for obtaining the distance.

FIG. 25A is a diagram showing a modified example of the output form of the distance information.

FIG. 25B is a diagram showing a modified example of the output form of the distance information.

FIG. 26A illustrates an example of a vehicle driving control system using the imaging device of the embodiment.

FIG. 26B illustrates an example of the vehicle driving control system.

FIG. 27 illustrates an example of a robot using the imaging device of the embodiment.

FIG. 28A illustrates an example of a drone.

FIG. 28B illustrates an example of the flight control system of the drone using the imaging device of the embodiment.

FIG. 29A illustrates an example of an automatic door system.

FIG. 29B illustrates an example of the automatic door system using the imaging device of the embodiment.

FIG. 30 is a block diagram showing an example of a monitoring system using the imaging device of the embodiment.

### DETAILED DESCRIPTION

Embodiments will be described hereinafter with reference to the accompanying drawings.

### First Embodiment

[Schematic Configuration]

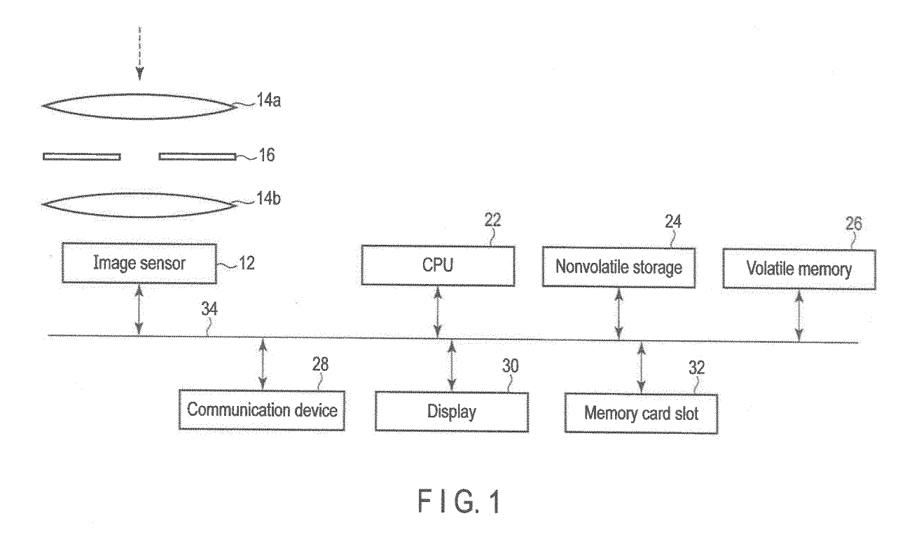

FIG. 1 shows an example of a schematic configuration of a first embodiment.

In general, according to one embodiment, an imaging device includes a first optical system configured to perform first image blurring and second image blurring to light from an object; an image capturing device configured to receive the light from the object through the first optical system and output a first image signal including first blur and a second image signal including second blur; and a data processor configured to generate distance information based on the first image signal and the second image signal.

The first embodiment is a system comprising an imaging device or a camera, and an image data processor. Light rays (an arrow of a broken line in the drawing) from an object are made incident on an image sensor 12. An imaging lens including a plurality of (two in the drawing for convenience) lenses 14a and 14b may be provided between the object and the image sensor 12. The light rays from the object may be made incident on the image sensor 12 through the lenses 14a and 14b. The image sensor 12 photoelectrically converts the incident light rays and outputs an image signal indicative of a moving image or a still image. Any sensors such as an image sensor of Charge Coupled Device (CCD) type, an image sensor of Complementary Metal Oxide Semiconductor (CMOS) type and the like can be used as the image sensor 12. For example, the lens 14b is movable along an optical axis and a focus is adjusted by movement of the lens 14b. A diaphragm 16 is provided between two lenses 14a and 14b. The diaphragm may be unadjustable. If the diaphragm is small, a focus adjustment function is unnecessary. The imaging lenses may include a zoom function. An imaging device includes the image sensor 12, the imaging lens 14, the diaphragm 16 and the like.

The image data processor includes a central processing unit (CPU) 22, a nonvolatile storage 24 such as a flash memory or a hard disk drive, a volatile memory 26 such as a Random Access Memory (RAM), a communication device 28, a display 30, a memory card slot 32 and the like. The image sensor 12, the CPU 22, the nonvolatile storage 24, the volatile memory 26, the communication device 28, the display 30, the memory card slot 32 and the like are mutually connected by a bus 34.

The imaging device and the image data processor may be formed separately or integrally. If the imaging device and the image data processor are formed integrally, they may be implemented as an electronic device equipped with a camera, such as a mobile telephone, a Smartphone, a Personal Digital Assistant (PDA) and the like. If the imaging device and the image data processor are formed separately, the data output from the imaging device implemented as a single-lens reflex camera or the like may be input to the image data processor implemented as a personal computer or the like by a cable or wireless means. The data is, for example, image data and distance data. In addition, the imaging device may be implemented as an embedded system built in various types of electronic devices.

The CPU 22 totally controls the operations of the overall system. For example, CPU 22 executes a capture control program, a distance calculation program, a display control program, and the like stored in the nonvolatile storage 24, and implements the functional blocks for capture control, distance calculation, display control, and the like. The CPU 22 thereby controls not only the image sensor 12 of the imaging device but the lens 14b, the diaphragm 16, the display 30 of the image data processor, and the like. In addition, the functional blocks for capture control, distance calculation, display control, and the like may be implemented by not the CPU 22 alone but exclusive hardware. A distance calculation program obtains the distance to the object for every pixel of a captured image, though details are described later.

The nonvolatile storage 24 includes a hard disk drive, a flash memory, and the like. The display 30 is composed a liquid crystal display, a touch panel, or the like. The display 30 executes the color display of the captured image, and displays the distance information obtained for each pixel, in a specific form, for example, as a depth map image in which the captured image is colored according to the distance. The distance information may not be displayed as the image, but displayed in a table form such as a correspondence relation table of the distance and the position, and the like.

For example, the volatile memory 26 including RAM, for example, Synchronous Dynamic Random Access Memory (SDRAM), or the like stores various types of data used for the programs and processing related with control of the overall system.

The communication device 28 is an interface which controls the communications with an external device and the input of various instructions made by the user who uses a keyboard, an operation button, and the like. The captured image and the distance information may not only be displayed on the display 30, but may be transmitted to external information via the communication device 28 and used by the external device having operations controlled based on the distance information. Examples of the external device include a traveling assistance system for a vehicle, a drone, and the like, a monitoring system which monitors intrusion of a suspicious person, and the like. Acquiring the distance information may be shared by a plurality of devices such that the image data processor executes a part of the processing for obtaining the distance from the image signals and the external devices such as a host execute the remaining parts of the processing.

Portable storage media such as a Secure Digital (SD) memory card, an SD High-Capacity (SDHC) memory card, and the like can be inserted in the memory card slot 32. The captured image and the distance information may be stored in the portable storage medium, the information in the portable storage medium may be read by the other device, and the captured image and the distance information may be therefore used by the other device. Alternatively, the image signal captured by the other imaging device may be input to the image data processor of the present system via the portable storage medium in the memory card slot 32, and the distance may be calculated based on the image signal. Furthermore, the image signal captured by the other imaging device may be input to the image data processor of the present system via the communication device 28.

[Image Sensor]

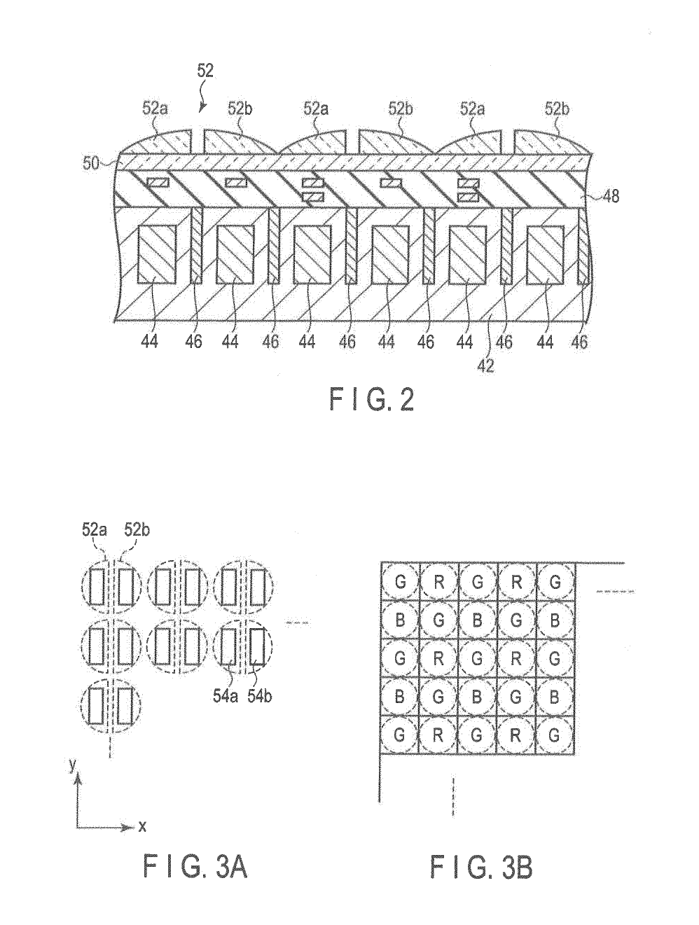

An image sensor, for example, a CCD image sensor 12 includes photodiodes serving as photo detectors arranged in a two-dimensional matrix, and a CCD which transfers the signal charges generated by executing photoelectric conversion of the incident light rays by the photodiodes. FIG. 2 shows an example of a cross-sectional structure of the photodiodes. A number of n-type semiconductor regions 44 are formed in the surface area of a p-type silicon substrate 42, and a number of photodiodes are formed by p-n junction between the p-type silicon substrate 42 and the n-type semiconductor regions 44. One pixel is formed by two photodiodes arranged in a lateral direction of FIG. 2. For this reason, each photodiode is also called a sub-pixel. A light shield 46 for suppression of crosstalk is formed between the photodiodes. A multilayered wiring layer 48 in which transistors, various interconnections, and the like are provided is formed on the p-type silicon substrate 42.

A color filter 50 is formed on the wiring layer 48. The color filter 50 includes a number of filter elements that are arranged in a two-dimensional array to transmit, for example, light rays of red (R), green (G) or blue (B) for each pixel. For this reason, each pixel generates only the image information of one of color components of R, G, and B. The picture information of color components of two other colors which are not generated in the pixel is obtained from the color component image information of surrounding pixels by interpolation. In capturing of a periodic repetition pattern, moire and a false color may occur in the interpolation. To prevent this, an optical low-pass filter (not shown) which is formed of quarts or the like to slightly obscure the repetition pattern may be arranged between the imaging lens 14 and the image sensor 12. The same effect may be obtained by the signal processing of the image signals instead of providing the optical low-pass filter.

A microlens array is formed on the color filter 50. The microlens array includes a number of microlenses 52 arranged in a two-dimensional array corresponding to the pixels. The microlenses 52 are provided for the respective pixels. The surface incident type image sensor 12 is illustrated in FIG. 2 but may be replaced with a backside incident type image sensor. Two, right and left, photodiodes constituting one pixel are configured to receive light rays transmitted through different areas on an exit pupil of the imaging lens 14 via left and right parts 52a and 52b of the microlens 52, and what is called pupil division is implemented. The microlens 52 may be or may not be divides into left and right parts 52a and 52b that lead light rays to the right and left photodiodes of each pixel. If the microlens is divided, the left part 52a and the right part 52b are different in shape as illustrated in FIG. 2.

FIG. 3A is a plan view showing an example of the relationship between the photodiodes 54a and 54b which constitute each pixel, and the microlens 52. The x-axis extends along a lateral direction, the y-axis extends along a longitudinal direction, and the lateral direction indicates the right and left direction seen from the image sensor 12. As shown in FIG. 3A, the photodiode 54a is located in the left half (right half seen from the object) of each pixel, and the light rays transmitted through the area of the right side seen from the object of the exit pupil is made incident on the photodiode 54a through the microlens 52a. The photodiode 54b is located in the right half (left half seen from the object) of each pixel, and the light rays transmitted through the area of the left side seen from the object of the exit pupil is made incident on the photodiode 54b through the microlens 52b.

FIG. 3B shows an example of the color filter 50. The color filter 50 is, for example, a primary color filter in Bayer array. The color filter 50 may be a complementary color filter. Furthermore, if a color image does not need to be captured and the only distance information needs to be obtained, the image sensor 12 does not need to be a color sensor but may be a monochrome sensor, and the color filter 50 may not be provided.

The arrangement of the photodiodes 54a and 54b constituting one pixel is not limited to an arrangement which divides the pixel into right and left parts as shown in FIG. 3A but may be an arrangement which divides a pixel into upper and lower parts. Furthermore, the direction of a parting line is not limited to a vertical direction or a horizontal direction, but the pixel may be divided obliquely.

[Difference in Image Formation by Distance]

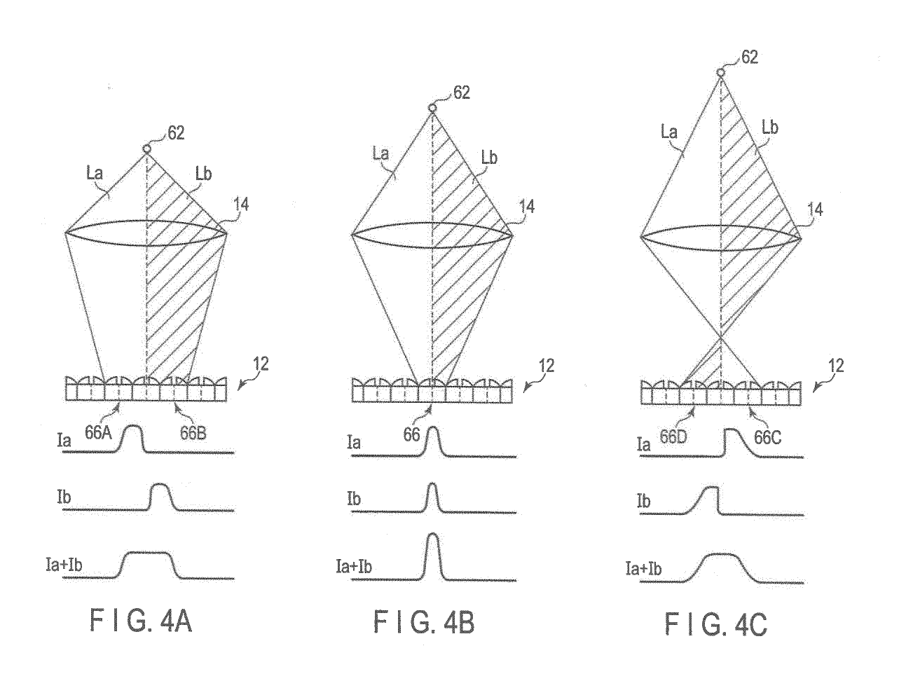

FIGS. 4A, 4B, and 4C show an example of image formation of an object in the image sensor 12. FIG. 4B shows image formation in an in-focus status where an object 62 is located on a focal plane. In this case, since an object image is formed on the imaging surface of the image sensor 12, two light rays La and Lb emitted from the object 62 on an optical axis and transmitted through the areas different in exit pupil of the imaging lens 14 are made incident on one pixel 66 on the optical axis. Two light rays emitted from the other object located on the focal surface but not on the optical axis, and transmitted through the areas different in exit pupil of the imaging lens 14 are also made incident on one pixel not on the optical axis. The light rays La transmitted through the left side (right side seen from the object) of the exit pupil of the imaging lens 14 are subjected to photoelectric conversion in the photodiode 54a on the left side of all the pixels. The light rays Lb transmitted through the right side (left side seen from the object) of the exit pupil of the imaging lens 14 are subjected to photoelectric conversion in the photodiode 54b on the right side of all the pixels. The sum of image signals Ia and Ib output from the left and right photodiodes 54a and 54b of all the pixels do not contain blur.

The captured image is generated by an addition signal Ia+Ib of the sum of image signals Ia and Ib output from two photodiodes 54a and 54b of all the pixels. Since only the light rays of any one of the color components R, G, and B are made incident on each pixel, the image signal Ia_{R}, Ia_{G}, or Ia_{B} (or Ib_{R}, Ib_{G}, or Ib_{B}) of any one of the color components R, G, and B is output from the photodiode 54a (or 54b) strictly. For convenience of explanations, however, the image signals Ia_{R}, Ia_{G}, or Ia_{B} (or Ib_{R}, Ib_{G}, or Ib_{B}) are totally called the image signals Ia (or Ib).

FIG. 4A shows the image formation in a front focus status in which the object 62 is located nearer to the image sensor 12 than the focal plane, i.e., the object 62 is located in front of the focal plane as seen from the image sensor 12. In this case, since the plane on which the object image is formed is located behind the image sensor 12 as seen from the imaging lens 14. In, two light rays La and Lb emitted from the object 62 on the optical axis and transmitted through the areas different in exit pupil of the imaging lens 14 are made incident on not only the pixel 66 on the optical axis but also the surrounding pixels, for example, 66A and 66B.

The sum of image signals Ia and Ib output from the left and right photodiodes 54a and 54b of all the pixels contain blur. Since blur is defined by a blur function (Point Spread Function: PSF), the blur is often called a blur function or PSF. The range of the pixels on which each of the light rays La and the light rays Lb is made incident corresponds to the distance to the object. In other words, the range of the pixels in which the light rays La and the light rays Lb are made incident becomes wider as the object 62 is located nearer to the imaging lens 14. The magnitude (quantity) of the blur becomes large as the object 62 is located away from the focal plane.

The light rays La transmitted through the left side of the exit pupil of the imaging lens 14 are subjected to photoelectric conversion in the photodiode 54a on the left side area of all the pixels. The light rays Lb transmitted through the right side area of the exit pupil of the imaging lens 14 are subjected to photoelectric conversion in the photodiode 54b on the right side of all the pixels. The pixel group in which the light rays La are made incident is located on the left side of the pixel group in which the light rays Lb are made incident.

FIG. 4C shows the image formation in a back focus status in which the object 62 is located behind the focal plane as seen from the image sensor 12. In this case, since the plane on which the object image is formed is in front of the image sensor 12 as seen from the object 62, two light rays La and Lb emitted from the object 62 on the optical axis and transmitted through the areas different in exit pupil of the imaging lens 14 are made incident on not only the pixel 66 on the optical axis but also the surrounding pixels, for example, 66C and 66D. The sum of image signals Ia and Ib output from the left and right photodiodes 54a and 54b of all the pixels contain blur. The range of the pixels on which the light rays La and the light rays Lb are made incident corresponds to the distance to the object. In other words, the range of the pixels in which the light rays La and the light rays Lb are made incident becomes wider as the object 62 moves to the back side of the focal plane as seen from the image sensor 12. The magnitude (quantity) of the blur becomes large as the object moves away from the focal plane.

The light rays La transmitted through the left side area of the exit pupil of the imaging lens 14 are subjected to photoelectric conversion in the photodiode 54a on the left side of all the pixels, and the light rays Lb transmitted through the right side area of the exit pupil of the imaging lens 14 are subjected to photoelectric conversion in the photodiode 54b on the right side of the pixel 66D. Unlike the front focus status shown in FIG. 4A, the pixel group on which the light rays La are made incident is present on the right side of the pixel group on which the light rays Lb are made incident.

A deviation direction of the blur indicated by the image signals Ia and Ib is inverted in accordance with the object located in front of or behind the focal plane. The object located in front of or behind the focal plane can be determined based on the deviation direction of the blur, and the distance to the object is obtained. To distinguish the blur where the object is located in front of the focal plane from the blur where the object is located behind the focal plane, the magnitude of the blur function (relative size of the blur function to the pixel size) where the object is located in front of the focal plane is referred to as minus, while the magnitude of the blur function where the object is located behind the focal plane is referred to as plus. The definitions of plus and minus may be opposite to these.

[Blur Function]

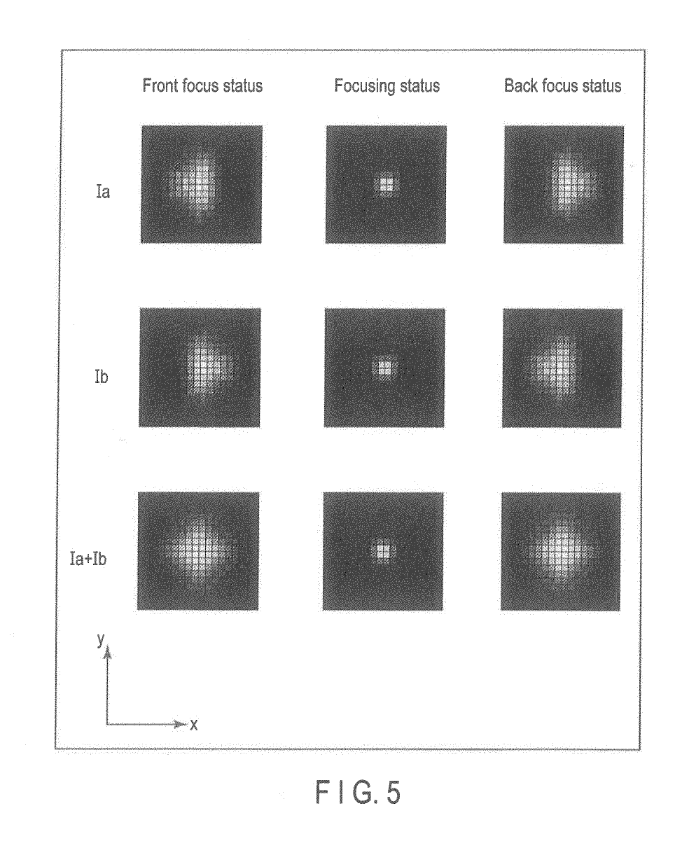

Next, variation in the shape of the blur function of the image corresponding to the object's position will be explained with reference to FIG. 5. The shape of the aperture of the diaphragm 16 is assumed to be a circle; in fact, the shape is a polygon but is regarded as a circle since the shape includes a number of angles.

If the object is located on the focal plane as shown in FIG. 4B, the shape of the blur function of each of the image signals Ia, Ib, and Ia+Ib is an approximately circular shape as shown in a central column of FIG. 5.

If the object is located in front of the focal plane as shown in FIG. 4A, the shape of the blur function of the image signal Ia output from the photodiode 54a located on the left side of the pixel is an approximately left semicircular shape losing the right side (actually, larger than a semicircle), and the shape of the blur function of the image signal Ib output from the photodiode 54b located on the right side of the pixel is an approximately right semicircular shape losing the left side, as shown in the left column of FIG. 5. The form of the blur function becomes larger as the distance (absolute value) between the object's position and the focal plane is longer. The shape of the blur function of the image signal Ia+Ib is an approximately circular shape.

If the object is located behind the focal plane as shown in FIG. 4C, the shape of the blur function of the image signal Ia output from the photodiode 54a located on the left side of the pixel is an approximately right semicircular shape losing the left side, and the shape of the blur function of the image signal Ib output from the photodiode 54b located on the right side of the pixel is an approximately left semicircular shape losing the right side, as shown in the right column of FIG. 5. The form of the blur function becomes larger as the distance (absolute value) between the object's position and the focal plane is longer. The shape of the blur function of the image signal Ia+Ib is an approximately circular shape.

As shown in FIG. 5, the blur function of the image signal Ia is deviated to the left side if the object is located in front of the focal plane, and the blur function is deviated to the right side if the object is located behind the focal plane. Contrary to the blur function of the image signal Ia, the blur function of the image signal Ib is deviated to the right side if the object is located in front of the focal plane, and the blur function is deviated to the left side if the object is located behind the focal plane. For this reason, the blur function of the addition signal Ia+Ib of both the image signals is located at the center irrespective of the object's position. The size of the blur function of the addition signal Ia+Ib becomes larger as the distance (absolute value) between the object's position and the focal plane is longer.

In the embodiments, the distance to the object is calculated by what is called Depth from Defocus (DfD) method, based on at least two images in which the shape of the blur function is varied in accordance with the positional relationship between the focal plane and the object. A correction filter (herein called a convolution kernel) for correcting the shape of the blur function of two images is prepared. Since the magnitude and shape of the blur function are varied in accordance with the distance to the object, a number of blur convolution kernels different in correction strength (degree of shape variation) for each distance to the object are prepared. The distance to the object can be calculated by obtaining a convolution kernel by which correlation between the corrected image including the corrected shape of the blur function and a reference image becomes higher.

The blur correction implies a first correction which makes the shape of the blur function of one of the images match the shape of the blur function of the other image, and a second correction which makes the shapes of the blur functions of both the images match the shape of a third blur function. For example, the first correction is used when correlation between the image signal Ia or Ib and the image signal Ia+Ib is operated, and the convolution kernel corrects the shape of the blur function of the image signal Ia or Ib to an approximately circular shape. For example, the second correction is used when correlation between the image signal Ia and the image signal Ib is operated, and the convolution kernel corrects the shape of the blur function of the image signals Ia and Ib to a specific shape of the third blur function.

The number of combinations of two images selected from three images are three (Ia and Ia+Ib; Ib and Ia+Ib; Ia and Ib). The distance may be determined based on the only one of the correlation calculation results but may also be determined by integrating two or three of the correlation calculation results. The example of integration may be a simple average, a weighted average, and the like.

If a distance from the lens to the object is d, the captured image signal Ix can be represented by equation 1 using captured image signal Iy including little blur and the blur function f(d) of a captured image. “*” represents a convolution operation.

Ix=f(d)*Iy (1)

The blur function f(d) of the captured image is determined based on the aperture shape of the diaphragm 16 and the distance d. As regards the sign of the distance d, d>0 if the object is located behind the focal plane, and d<0 if the object is located in front of the focal plane.

An image signal Ia+Ib from which the shape of the blur function is not changed according to the distance is referred to as the reference image signal Ixᵣ, and the image signal Ia or Ib is referred to as the object image signal Ixₒ.

As shown in FIG. 5, the blur function f(d) of the reference image signal Ixᵣ (image signal Ia+Ib) does not change in shape even if the object is located before and behind the focal plane, and expressed as a Gaussian function by which the width changes according to the magnitude of the distance d |d|. The blur function f(d) may be expressed as a pillbox function by which the width changes according to the magnitude of the distance d |d|.

The reference image signal Ixᵣ (image signal Ia+Ib) can be represented by equation 2 using the blur function fᵣ(d) determined by the aperture shape of the diaphragm and the distance d, similarly to equation 1.

Ixᵣ=fᵣ(d)*Iy (2)

The object image signal Ixₒ (image signal Ia or Ib) can be represented by equation 3 using the blur function fₒ(d) determined by the aperture shape of the diaphragm and the distance, similarly to equation 1.

Ixₒ=fₒ(d)*Iy (3)

The blur function fᵣ(d) of the reference image signal Ixᵣ (image signal Ia+Ib) is equal to f(d). The blur function fₒ(d) of the target image signal Ixₒ (image signal Ia or Ib) changes in shape before and behind d=0 (focal plane). As shown in FIG. 5, the blur function fₒ(d) of the target image signal Ixₒ (image signal Ia or Ib) becomes a Gaussian function of a short width as a result that the left (or right) component is attenuated, if the object is located behind the focal plane (d>0), and becomes a Gaussian function of a short width as a result that the right (or left) component is attenuated, if the object is located in front of the focal plane (d<0).

The convolution kernel f_{c}(d) serving as a blur function which matches the shape of the blur function of the target image signal Ixₒ (image signal Ia or Ib) and the shape of the blur function of the reference image signal Ixᵣ (image signal Ia+Ib), in a certain distance d, can be represented by equation 4.

Ixᵣ=f_{c}(d)*Ixₒ (4)

The convolution kernel f_{c}(d) of equation 4 can be represented by equation 5 using the blur function fᵣ(d) of the reference image signal Ixᵣ and the blur function fₒ(d) of the object image signal Ixₒ, with reference to equations 2 to 4.

f_{c}(d)=fᵣ(d)*f₀⁻¹(d) (5)

In equation 5, f₀⁻¹(d) is an inverted function of the blur function fₒ(d) of the target image.

Based on these, the convolution kernel f_{c}(d) can be analyzed and calculated from the blur function of the reference image signal Ixᵣ and the object image signal Ixₒ. The blur function of the target image signal Ixₒ in a certain distance can be corrected to a blur function of various shapes corresponding to the arbitrary distance d by using the convolution kernel f_{c}(d).

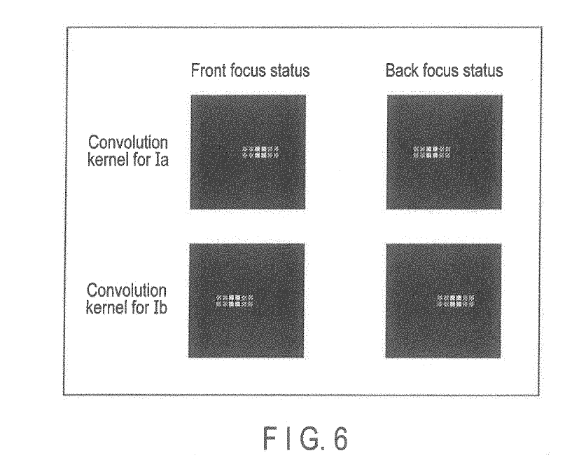

FIG. 6 shows an example of the convolution kernel which corrects the approximately semicircular blur function of the image signal Ia or Ib to the approximately circular blur function of the image signal Ia+Ib. The convolution kernel has a component on the x-axis. The convolution kernel in which the filter component is distributed on the right side is used if the blur function of the image is deviated to the left side, and the blur convolution kernel in which the filter component is distributed on the left side is used if the blur function of the image is deviated to the right side.

[Blur Correction]

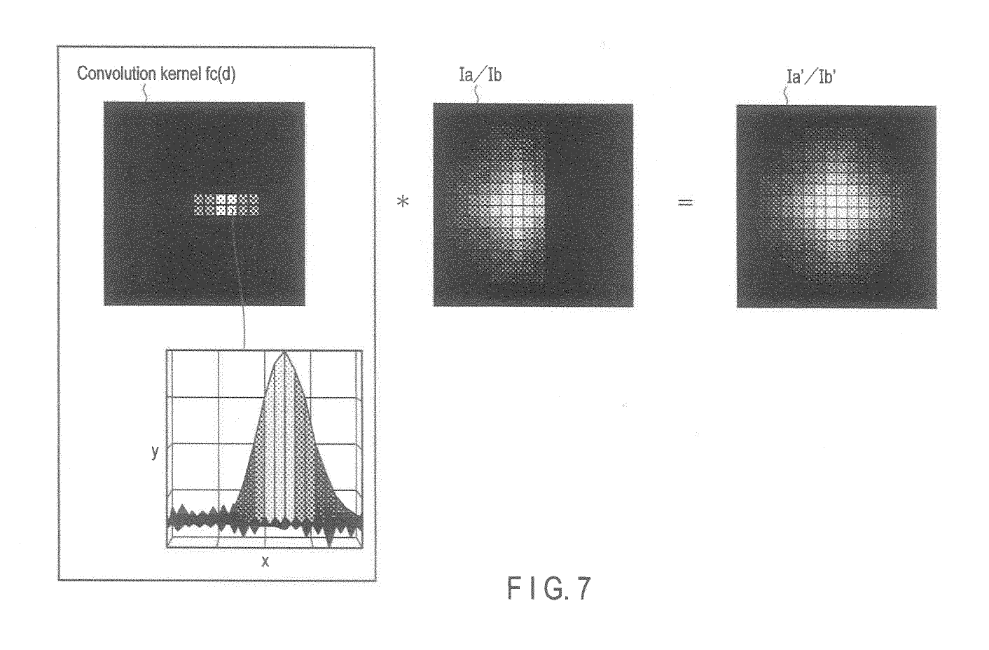

FIG. 7 shows an example of the blur correction. If the blur function of the image signal Ixₒ (image signal Ia or Ib) to be corrected is corrected by using the convolution kernel f_{c}(d) in the arbitrary distance d, the corrected image signal I′xₒ(d) (image signal Ia′ or Ib′) can be represented by equation 6.

I′xₒ(d)=f_{c}(d)*Ixₒ (6)

It is determined whether the corrected image signal I′xₒ(d) having the corrected blur function matches the reference image signal Ixᵣ (image signal Ia+Ib) or not. If the image signals match, the distance d concerning the convolution kernel f_{c}(d) can be determined as the distance to the object. Matching of the image signals may imply not only a state in which the image signals completely match, but also a state in which, for example, the degree of matching is smaller than a predetermined threshold value. The degree of matching of the image signals can be calculated based on, for example, correlation between the corrected image signal I′xₒ(d) in a rectangular area of an arbitrary size about each pixel and the reference image signal Ixᵣ. Examples of the correction calculation include Sum of Squared Difference (SSD), Sum of Absolute Difference (SAD), Normalized Cross-Correlation (NCC), Zero-mean Normalized Cross-Correlation (NCC), Color Alignment Measure, and the like.

[Distance Calculation]

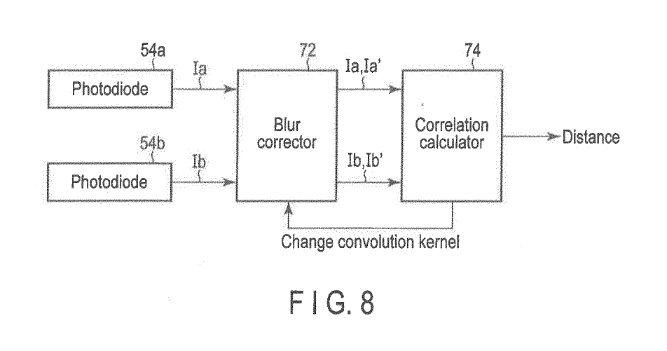

FIG. 8 shows an example of a distance calculation according to the first embodiment. FIG. 8 shows a diagram of functional blocks implemented by executing the distance calculation program by the CPU 22. The outputs of the photodiodes 54a and 54b of all the pixels are input to a blur corrector 72. The blur corrector 72 includes the convolution kernel f_{c}(d) as represented in equation 5 concerning a number of distances d, operates the convolution kernel for the image signal Ia output from the photodiode 54a, the image signal Ib output from the photodiode 54b, or the outputs of both the photodiodes 54a and 54b, Ia+Ib, and changes their blur functions. The blur corrector 72 outputs the input image signals Ia and Ib as well as the corrected image signals Ia′ and Ib′. The output of the blur corrector 72 is input to a correlation calculator 74. The correlation calculator 74 determines a convolution kernel by which correlation between two images is maximized in each pixel, and outputs the distance corresponding to the convolution kernel as the distance to the object.

In addition, the functional blocks shown in FIG. 8 may not be implemented by executing the program by the CPU 22 but may be implemented by exclusive hardware.

The convolution kernel f_{c}(d) represented in equation 5 is, for example, a filter in which the blur function of the target image signal Ixₒ (image signal Ia or Ib) matches the blur function of the reference image signal Ixᵣ (image signal Ia+Ib). However, aspects of the correction are not limited to this, but the blur function of the reference image signal Ixᵣ (image signal Ia+Ib) may match the blur function of the target image signal Ixₒ (image signal Ia or Ib), and the blur function of the target image signal Ixₒ (image signal Ia or Ib) and the blur function of the reference image signal Ixᵣ (image signal Ia and Ib) may match a third blur function.

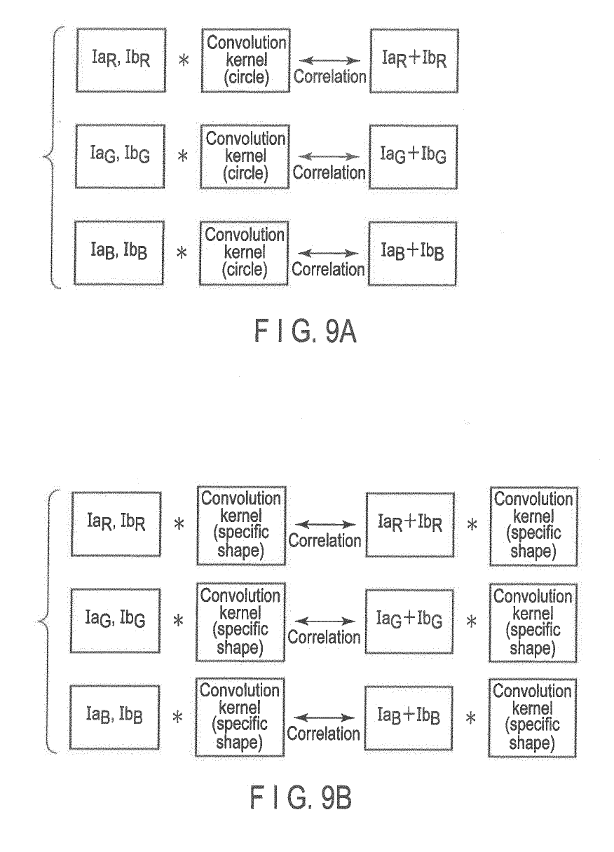

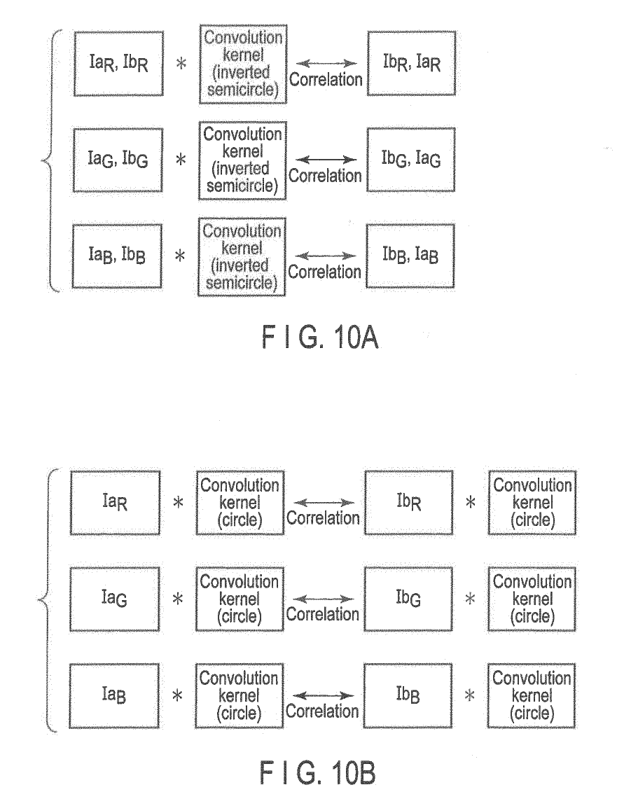

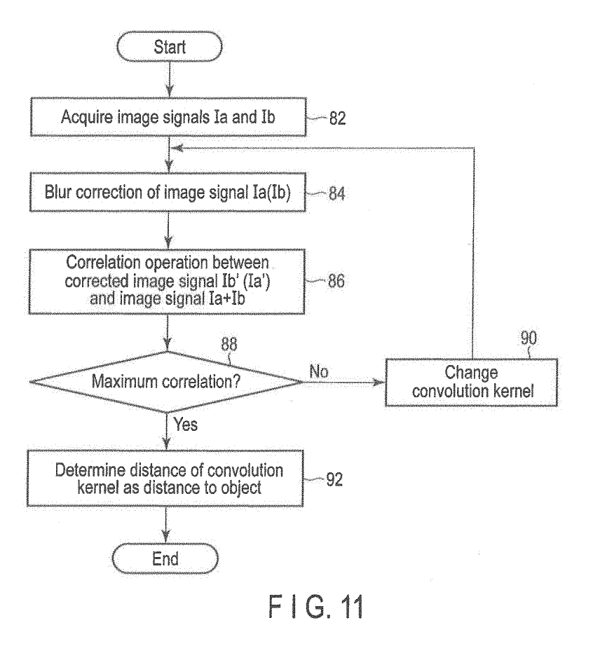

Several examples of the combination of two images for correlation operation are shown in FIGS. 9A and 9B and FIGS. 10A and 10B. In the explanations, R image signal Ia_{R}, G image signal Ia_{G} or B image signal Ia_{B} is output from the photodiode 54a while R image signal Ib_{R}, G image signal Ib_{G} or B image signal Ib_{B} is output from the photodiode 54b.

FIG. 9A shows an example in which the image signal Ia or Ib output from the photodiodes 54a and 54b is assumed as the target image while the image signal Ia+Ib of the same color component is assumed as the reference image. As regards the R image, the object image signal Ia_{R} or Ib_{R} is subjected to convolution operation with a convolution kernel which corrects the approximately semicircular blur function as shown in FIG. 6 to an approximately circular blur function, and a corrected target image signal Ia_{R}′ or Ib_{R}′ is obtained. Correlation between the corrected target image signal Ia_{R}′ or Ib_{R}′ and the reference image signal Ia_{R}+Ib_{R} is calculated.

As regards the G image, the object image signal Ia_{G} or Ib_{G} is subjected to convolution operation with a convolution kernel which corrects the approximately semicircular blur function to an approximately circular blur function, a corrected target image signal Ia_{G}′ or Ib_{G}′ is obtained. Correlation between the corrected target image signal Ia_{G}′ or Ib_{G}′ and the reference image signal Ia_{G}+Ib_{G} is calculated.

As regards the B image, too, the object image signal Ia_{B} or Ib_{B} is subjected to convolution operation with a convolution kernel which corrects the approximately semicircular blur function to an approximately circular blur function, a corrected target image signal Ia_{B}′ or Ib_{B}′ is obtained. Correlation between the corrected target image signal Ia_{B}′ or Ib_{B}′ and the reference image signal Ia_{B}+Ib_{B} is calculated.

FIG. 9B shows an example in which the image signal Ia or Ib is assumed as the target image, the image signal Ia+Ib of the same color component is assumed as the reference image, and both the target image and the reference image are corrected to a blur function of a specific shape. As regards the R image, the object image signal Ia_{R} or Ib_{R} is subjected to convolution operation with a convolution kernel which corrects the approximately semicircular blur function as shown in FIG. 6 to a blur function of a specific shape, for example, a polygon, and a corrected target image signal Ia_{R}′ or Ib_{R}′ is obtained. The reference image signal Ia_{R}+Ib_{R} is subjected to convolution operation with a convolution kernel which corrects the approximately semicircular blur function to a blur function of a specific shape, for example, a polygon, and a corrected target image signal Ia_{R}′ or Ib_{R}′ is obtained. Correlation between the corrected target image signal Ia_{R}′ or Ib_{R}′ and the corrected reference image signal Ia_{R}′+Ib_{R}′ is calculated.

As regards the G image, the object image signal Ia_{G} or Ib_{G} is subjected to convolution operation with a convolution kernel which corrects the approximately semicircular blur function to a blur function of a specific shape, for example, a polygon, and a corrected target image signal Ia_{G}′ or Ib_{G}′ is obtained. The reference image signal Ia_{G}+Ib_{G} is subjected to convolution operation with a convolution kernel which corrects the approximately semicircular blur function to a blur function of a specific shape, for example, a polygon, and a corrected target image signal Ia_{G}′ or Ib_{G}′ is obtained. Correlation between the corrected target image signal Ia_{G}′ or Ib_{G}′ and the corrected reference image signal Ia_{G}′+Ib_{G}′ is calculated.

As regards the B image, the object image signal Ia_{B} or Ib_{B} is subjected to convolution operation with a convolution kernel which corrects the approximately semicircular blur function to a blur function of a specific shape, for example, a polygon, and a corrected target image signal Ia_{B}′ or Ib_{B}′ is obtained. The reference image signal Ia_{B}+Ib_{B} is subjected to convolution operation with a convolution kernel which corrects the approximately semicircular blur function to a blur function of a specific shape, for example, a polygon, and a corrected target image signal Ia_{B}′ or Ib_{B}′ is obtained. Correlation between the corrected target image signal Ia_{B}′ or Ib_{B}′ and the corrected reference image signal Ia_{B}′+Ib_{B}′ is calculated.

FIG. 10A shows an example in which the image signal Ia or Ib is used as the target image while the image signal Ib or Ia of the same color component is used as the reference image. As regards the R image, the object image signal Ia_{R} or Ib_{R} is subjected to convolution operation with a convolution kernel which corrects the left or right, approximately semicircular blur function to a right or left, approximately semicircular blur function which is a blur function of the reference image Ib_{R} or Ia_{R}, and a corrected target image signal Ia_{R}′ or Ib_{R}′ is obtained. Correlation between the corrected target image signal Ia_{R}′ or Ib_{R}′ and the reference image signal Ib_{R} or Ia_{R} is calculated.

As regards the G image, too, the object image signal Ia_{G} or Ib_{G} is subjected to convolution operation with a convolution kernel which corrects the left or right, approximately semicircular blur function to a right or left, approximately semicircular blur function which is a blur function of the reference image Ib_{G} or Ia_{G}, and a corrected target image signal Ia_{G}′ or Ib_{G}′ is obtained. Correlation between the corrected target image signal Ia_{G}′ or Ib_{G}′ and the reference image signal Ib_{G} or Ia_{G} is calculated.

As regards the B image, too, the object image signal Ia_{B} or Ib_{B} is subjected to convolution operation with a convolution kernel which corrects the left or right, approximately semicircular blur function to a right or left, approximately semicircular blur function which is a blur function of the reference image Ib_{B} or Ia_{B}, and a corrected target image signal Ia_{B}′ or Ib_{B}′ is obtained. Correlation between the corrected target image signal Ia_{B}′ or Ib_{B}′ and the reference image signal Ib_{B} or Ia_{B} is calculated.

FIG. 10B shows an example in which the image signal Ia or Ib is assumed as the target image while the image signal Ib or Ia of the same color component is assumed as the reference image. The correction of the blur functions of both the images may change the blur function to a blur function having an arbitrary shape. Correction of the shape of the blur functions of both the images to an approximately circular shape will be explained. As regards the R image, the first image signal Ia_{R} is subjected to convolution operation with a convolution kernel which corrects the shape of the blur function from an approximately semicircular shape to an approximately circular shape, and a first corrected image signal Ia_{R}′ is obtained. The second image signal Ib_{R} is subjected to convolution operation with a convolution kernel which corrects the shape of the blur function from an approximately semicircular shape to an approximately circular shape, and a second corrected image signal Ib_{R}′ is obtained. Correlation between the first corrected image signal Ia_{R}′ and the second corrected image signal Ib_{R}′ is calculated.

As regards the G image, too, the first image signal Ia_{G} is subjected to convolution operation with a convolution kernel which corrects the shape of the blur function from an approximately semicircular shape to an approximately circular shape, and a first corrected image signal Ia_{G}′ is obtained. The second image signal Ib_{G} is subjected to convolution operation with a convolution kernel which corrects the shape of the blur function from an approximately semicircular shape to an approximately circular shape, and a second corrected image signal Ib_{G}′ is obtained. Correlation between the first corrected image signal Ia_{G}′ and the second corrected image signal Ib_{G}′ is calculated.

As regards the B image, too, the first image signal Ia_{B} is subjected to convolution operation with a convolution kernel which corrects the shape of the blur function from an approximately semicircular shape to an approximately circular shape, and a first corrected image signal Ia_{B}′ is obtained. The second image signal Ib_{B} is subjected to convolution operation with a convolution kernel which corrects the shape of the blur function from an approximately semicircular shape to an approximately circular shape, and a second corrected image signal Ib_{B}′ is obtained. Correlation between the first corrected image signal Ia_{B}′ and the second corrected image signal Ib_{B}′ is calculated.

FIG. 11 is a flowchart showing a flow of the distance calculation in the functional block diagram shown in FIG. 8. In block 82, the blur corrector 72 inputs the image signals Ia and Ib output from two photodiodes 54a and 54b of each pixel of the image sensor 12. The types of the correlation operation are the same as those shown in FIG. 9A. For this reason, in block 84, the blur corrector 72 executes convolution operation of image signal Ia (or Ib) with the convolution kernel corresponding to a certain distance d1 in the convolution kernel group for correcting the shape of the blur function from the left and right (or right and left), approximately semicircular shape to the approximately circular shape. In block 86, the correlation calculator 74 calculates correlation between the corrected image signal Ia′ (or Ib′) and the image signal Ia+Ib serving as the reference for every pixel by SSD, SAD, NCC, ZNCC, Color Alignment Measure, and the like.

In block 88, the correlation calculator 74 determines whether the maximum value of the correlation has been detected or not. If the maximum value is not detected, the correlation calculator 74 instructs the blur corrector 72 to change the convolution kernel. The blur corrector 72 selects a convolution kernel corresponding to another distance d1+α, from one convolution kernel group, in block 90, and executes convolution operation of both the image signal Ia (or Ib) and the selected convolution kernel, in block 84.

The processing of FIG. 11 is performed for each pixel. If the maximum value of correlation for each pixel is detected in block 88, the correlation calculator 74 determines the distance corresponding to the convolution kernel which makes the correlation maximum as the distance to the object, in block 92. An example of the output of the distance information output from the correlation calculator 74 is a depth map image. The CPU 22 displays the captured image on the display 30 based on the image signal Ia+Ib, and also displays the depth map image in which the distance information is superposed on the captured image and colored in accordance with the distance (for example, red on the nearest side, blue on the farthest side, and the color changes in accordance with the distance) on the display 30. Since the distances can be distinguished according to the colors in the depth map image, the user can intuitively recognize the depth of the object. A number of examples can be considered as the method of outputting the distance information according to use.

According to the first embodiment, the microlens (a single microlens or two divided microlenses) is provided for each pixel, two photodiodes included in one pixel share the microlens, and one pixel can be considered to be formed of two photodiodes different in characteristics. For this reason, light rays from the object are subjected to pupil division and two light rays transmitted through different areas in exit pupil are made incident on two photodiodes, respectively. Since two images output from two photodiodes have different blur functions and the shapes of the blur functions are different in accordance with the distance to the object, the distance to the object can be obtained based on comparison of the blur function of at least one of two images output from these two photodiodes with the blur function of the reference image. Since the distance is obtained based on comparison of the blur functions of two images, the distance can be obtained correctly even if the object includes the repeated pattern.

### Modified Example 1 of Pupil Division

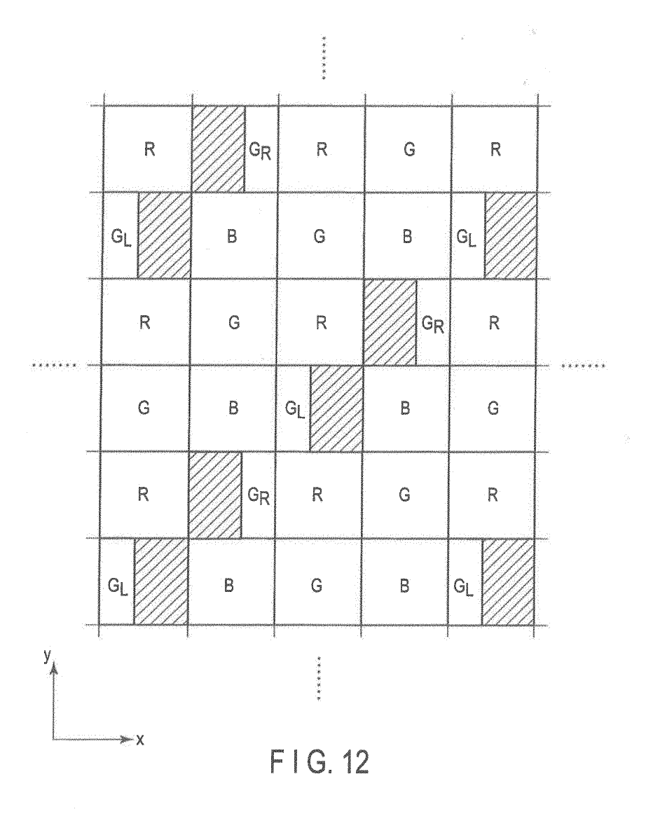

A modified example which executes pupil division of the light rays from the object by means other than the microlens will be explained. An example of the image sensor which can execute pupil division even when one photodiode is disposed in one pixel is shown in FIG. 12. FIG. 12 shows a light receiving surface of the image sensor. A color filter in which R, G, and B filter elements are arranged in Bayer array similarly to the first embodiment is provided on a light receiving surface, but openings of several pixels are covered with light shields (oblique-line areas in the drawing). The shielded pixels are pixels for distance measurement which are not used for image capture. Any one of the R, G, and B pixels may be used as the pixel for distance measurement, but several pixels of most arranged G pixels may be used as the pixels for distance measurement.

A pair of pixels adjacent to an oblique direction is shielded, i.e., G pixel G_{R} on the upper right side and G pixel G_{L} on the lower left side are shielded, and a light shielding area is complementary. For example, a left side area is shaded in the upper right G pixel G_{R}, and a right side area is shaded in the lower left G pixel G_{L}. Thus, the light rays transmitted through the right side area of the exit pupil are made incident on either of a pair of G pixels, and the light rays transmitted through the left side area of the exit pupil are made incident on the other pixel. The G pixels G_{R}, G_{L} for distance measurement are uniformly dispersed in the full screen such that the shields do not disturb capturing of image. The image signals of the G pixels G_{R}, G_{L} for distance measurement are generated from the image signals of surrounding G pixels for imaging, by interpolation.

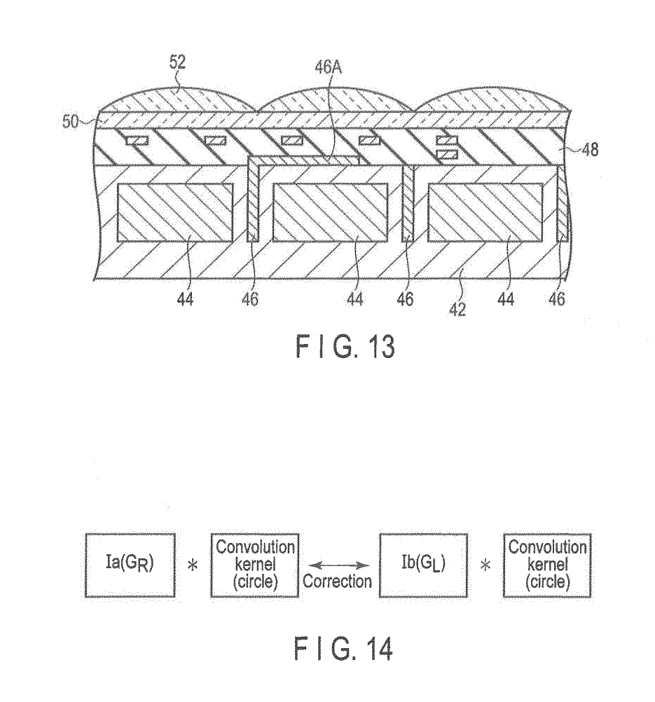

FIG. 13 shows an example of a cross-sectional structure near the photodiodes in the image sensor shown in FIG. 12. This example is different from the first embodiment shown in FIG. 2 in that only one n-type semiconductor area 44 (photodiode) is formed under the microlens 52 and that several parts of pixel openings under several microlenses 52 are shaded. An upper end of several light shields 46 between pixels is extended along the surface of the p-type substrate 42, and used as a light shield 46A of the pixel opening.

The image signal output from the G_{R} pixel having the left side shaded is equivalent to the image signal Ia of the first embodiment, and the shape of the blur function is an approximately semicircular shape. The image signal output from the G_{L} pixel having the right side shaded is equivalent to the image signal Ib of the first embodiment, and the shape of the blur function is an approximately semicircular shape, which is a laterally inverted, approximately semicircular shape, i.e., the shape of the blur function of the image output from the G_{R} pixel. For this reason, for example, as shown in FIG. 14, both the convolution kernel which corrects the shape of the blur function to an approximately circular shape and the image signal Ia output from the G_{R} pixel are subjected to convolution operation, both the convolution kernel which corrects the shape of the blur function to an approximately circular shape and the image signal Ib output from the G_{L} pixel are subjected to convolution operation, and the correlation between both of the operation results is calculated. The correlation is not limited to correlation between two images shown in FIG. 14 but may be correlation of any one of the combinations of images shown in FIGS. 9A and 9B and FIGS. 10A and 10B.

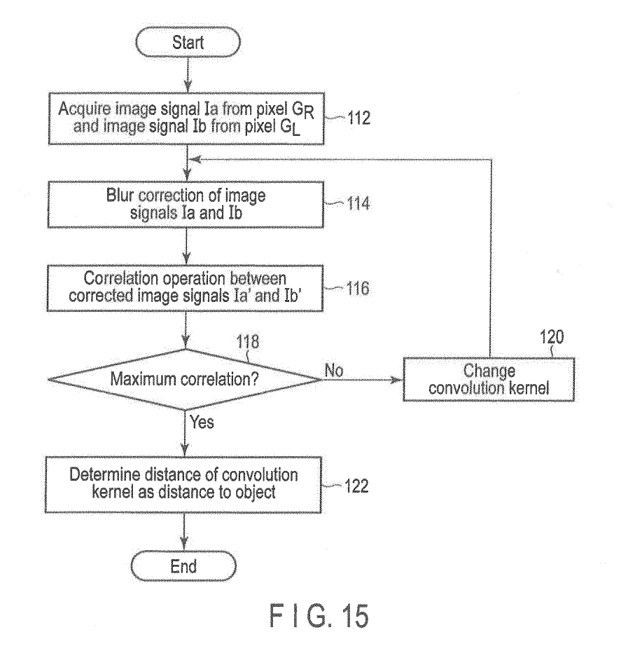

FIG. 15 is a flowchart of the processing in which the blur corrector 72 and the correlation calculator 74 shown in FIG. 8 calculate the distance by using the image sensor shown in FIG. 12 and FIG. 13. In block 112, the blur corrector 72 inputs the image signals Ia and Ib output from the light shielding pixels G_{R} and G_{L} of the image sensor 12. In block 114, the blur corrector 72 executes convolution operation of image signal Ia with the convolution kernel corresponding to a certain distance d1 in the convolution kernel group for correcting the shape of the blur function to the approximately circular shape, and obtains a corrected image signal Ia′. Similarly, the blur corrector 72 executes convolution operation of image signal Ib with the convolution kernel corresponding to the certain distance d1 in the convolution kernel group for correcting the shape of the blur function to the approximately circular shape, and obtains a corrected image signal Ib′. In block 116, the correlation calculator 74 calculates the correlation between the corrected image signals Ia′ and Ib′ for each pixel as shown in FIG. 14.

In block 118, the correlation calculator 74 determines whether the maximum value of the correlation has been detected or not. If the maximum value is not detected, the correlation calculator 74 instructs the blur corrector 72 to change the convolution kernel. The blur corrector 72 selects a convolution kernel corresponding to another distance d1+α, from the convolution kernel group, in block 120, and executes convolution operation of the image signals Ia and Ib and the selected convolution kernel, in block 114.

If the maximum value of correlation for each pixel is detected in block 118, the correlation calculator 74 determines the distance corresponding to the convolution kernel which makes the correlation maximum as the distance to the object, in block 122.

### Modified Example 2 of Pupil Division

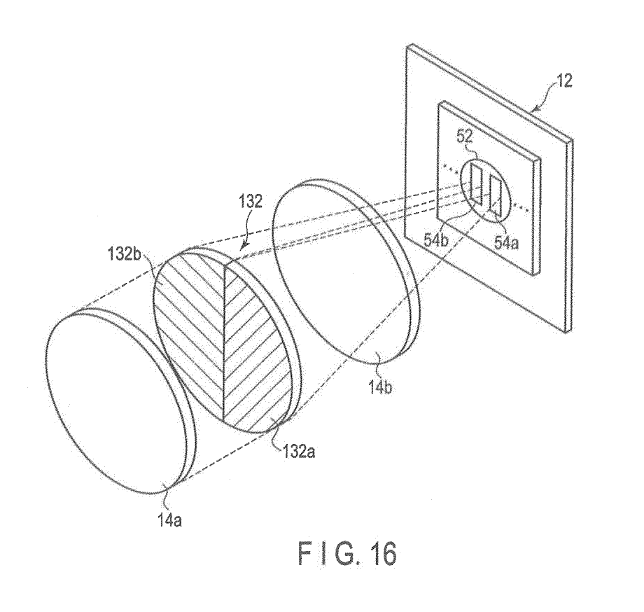

The pupil division is implemented by the microlens in the first embodiment, and a modified example in which pupil division is executed by a combination of a microlens and a polarizing element is shown in FIG. 16. A polarizing element 132 is arranged on a plane conjugate with an exit pupil of the lens 14. The polarizing element 132 is divided into two areas 132a and 132b about a perpendicular axis, and a polarizing axis of the area 132a and the polarizing axis of the area 132b are orthogonal to each other. Since the polarizing element 132 is arranged near the pupil position, a pupil area is divided into two partial pupil areas corresponding to the areas 132a and 132b.

The light rays from the object which are made incident on the lens 14 are changed to two polarized light rays by the polarizing element 132, which are orthogonal to each other. The polarized light rays transmitted through the area 132a are made incident on the left photodiode 54a, and the polarized light rays transmitted through the area 132b are made incident on the right photodiode 54b. Thus, since the image signals Ia and Ib output from the photodiodes 54a and 54b of FIG. 16 are equivalent to the image signals Ia and Ib of the first embodiment, the same operation processing as the first embodiment can be executed for the image signals Ia and Ib. The polarizing element 132 may be arranged on the object side from the lens 14a or the image sensor 12 side from the lens 14b, instead of being arranged between the lenses 14a and 14b as shown in the drawing.

The other embodiments will be explained below. In the other embodiments, the same constituent elements as those of the first embodiment are denoted by the same reference numbers and detailed descriptions are omitted.

### Second Embodiment

In the first embodiment, the blur functions of the light rays of the color which are transmitted through the different areas in exit pupil by pupil division are different in shape, and the distance is obtained based on the fact that the shape of the blur function changes in accordance with the distance. The blur function used in the first embodiment is not different in color. The distance is obtained by using the blur function in the second embodiment, too, but in the second embodiment, a convolution kernel which changes the shape of the blur function in accordance with color is added to a lens aperture, and the distance is obtained based on the fact that the shape of the blur function changes in accordance with colors, in addition to the fact that the blur functions of the light rays transmitted through the different areas in exit pupil are different in shape.

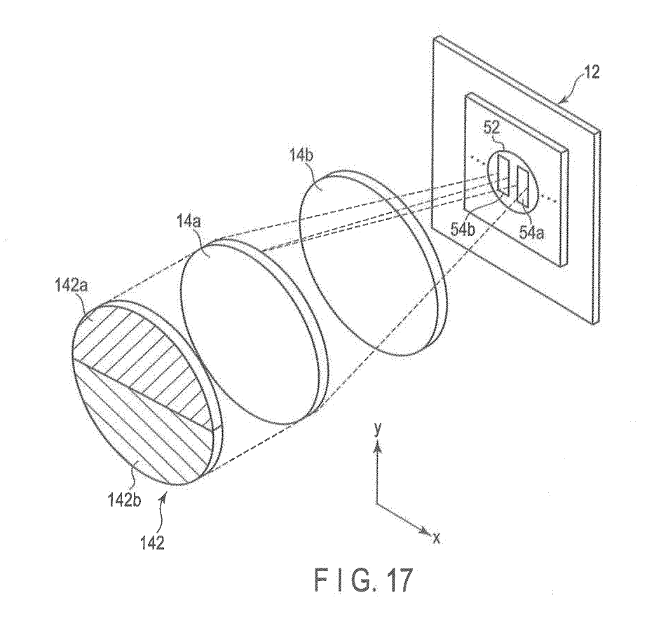

FIG. 17 schematically shows an imaging device according to the second embodiment. Since the whole system other than an imaging device is the same as the first embodiment shown in FIG. 1, illustration is omitted. A color filter 142 is arranged at a lens aperture on which the light rays from the object are made incident. For example, the color filter 142 is arranged in front of the lens 14. To distinguish from the color filter 50 (shown in FIG. 2 though illustration in FIG. 17 is omitted) located on the image forming surface of the image sensor 12, the color filter 142 is hereinafter called a color aperture. The color aperture 142 is divided into two areas 142a and 142b by a linear parting line. The direction of the parting line is arbitrary but may be orthogonal to the parting line (vertical direction) of two photodiodes 54a and 54b constituting the pixel. The color aperture 142 may be arranged between the lenses 14a and 14b or on the image sensor 12 side from the lens 14b, instead of being arranged on the object side from the lens 14a as shown in the drawing.

Two areas 142a and 142b of the color aperture 142 transmit the light rays of a plurality of different color components. For example, an upper area 142a is a yellow (Y) filter through which light rays of G component (hereinafter called G light rays) and light rays of R component (hereinafter called R light rays) are transmitted, and a lower area 142b is a cyan (C) filter through which G light rays and light rays of B component (hereinafter called B light rays) are transmitted. To increase a quantity of light rays to be transmitted, the surface of the color aperture 152 may be parallel to the imaging surface of the image sensor 12.

The combination of colors transmitted through the first area 142a and the second area 142b is not limited to the above-explained combination. For example, the first area 142a may be Y filter through which G light rays and R light rays are transmitted, and the second area 142b may be a magenta (M) filter through which G light rays and B light rays are transmitted. Furthermore, the first area 142a may be M filter and the second area 142b may be C filter. Moreover, either of the areas may be a transparent filter through which light rays corresponding to all the color components are transmitted. For example, when the image sensor 12 includes a pixel which detects the first wavelength band, a pixel which detects the second wavelength band, and a pixel which detects the third wavelength band, the light rays of the first and second wavelength bands are transmitted but the light rays of the third wavelength band are not transmitted through the first area 142a. The light rays of the second and third wavelength areas are transmitted through the second area 142b but the light rays of the first wavelength band are not transmitted through the second area 142b.

A part of the wavelength band of the light rays which are transmitted through either of the areas of the color aperture 142 may be overlapped on a part of the wavelength band of the light rays which are transmitted through the other area. The wavelength band of the light rays transmitted through either of the areas of the color aperture 142 may include the wavelength band of the light rays transmitted through the other area.

The fact that the light rays of a certain wavelength band are transmitted through the area of the color aperture 142 means that the light rays of the wavelength band are transmitted at a high transmissivity in the area and that attenuation of the light rays of the wavelength band (i.e., reduction of the quantity of light) in the area is extremely small. In addition, the fact that the light rays of a certain wavelength band are not transmitted through the area of the color aperture 142 means that the light rays are blocked (for example, reflected) or attenuated (for example, absorbed) in the area.

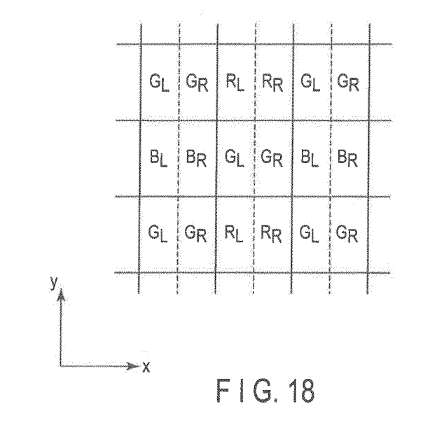

FIG. 18 shows an example of pixel array of the color filter 50 on an image forming plane of the image sensor 12. In the second embodiment, too, the color filter 50 is a color filter of the Bayer array in which the G pixels are twice as many as the R pixels and the B pixels. For this reason, the light rays corresponding to G are transmitted through both of the filter areas 142a and 142b such that a quantity of received light rays of the image sensor 12 increases. The photodiode 54a corresponds to sub-pixels R_{R}, G_{R}, and B_{R} on the right side (left side seen from the image sensor 12), and the photodiode 54b corresponds to sub-pixels R_{L}, G_{L}, and B_{L} on the left side (right side seen from the image sensor 12). Image signals Ia_{R} and Ib_{R} are output from the R pixel for every sub-pixels R_{R} and R_{L}, image signals Ia_{G} and Ib_{G} are output from the G pixel for every sub-pixels G_{R} and G_{L}, and image signals Ia_{B} and Ib_{B} are output from the B pixel for every sub-pixels B_{R} and B_{L}.

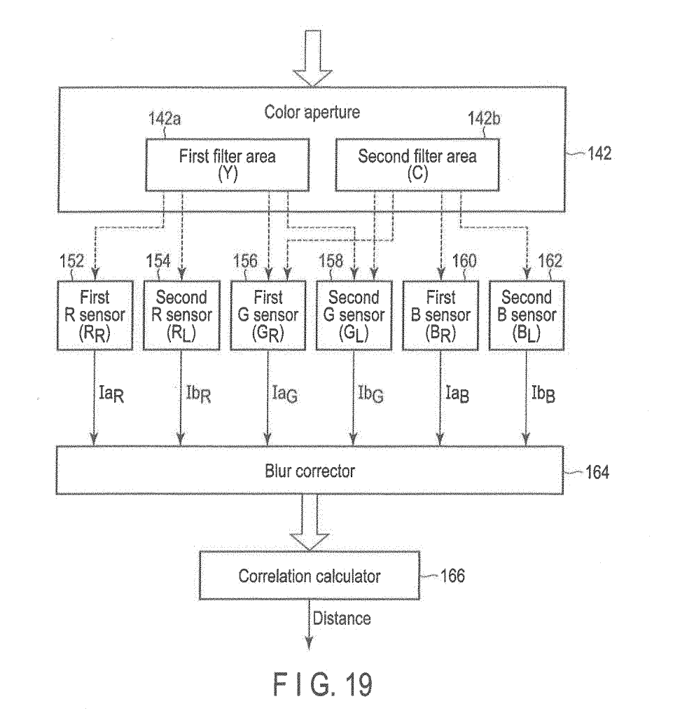

FIG. 19 is a block diagram showing an example of a functional configuration of the second embodiment. A broken line indicates a passage of light rays and a solid line indicates a passage of an electronic signal. The light rays transmitted through the area on the left side (right side seen from the object) of the exit pupil, of the R light rays transmitted through the first filter area (Y) 142a of the color aperture 142, are made incident on a first R sensor (sub-pixel R_{R}) 152. The light rays transmitted through the area on the right side (left side seen from the object) of the exit pupil, of the R light rays transmitted through the first filter area (Y) 142a of the color aperture 142, are made incident on a second R sensor (sub-pixel R_{L}) 154. The light rays transmitted through the area on the left side (right side seen from the object) of the exit pupil, of the G light rays transmitted through the first filter area (Y) 142a of the color aperture 142, are made incident on a first G sensor (sub-pixel G_{R}) 156. The light rays transmitted through the area on the right side (left side seen from the object) of the exit pupil, of the G light rays transmitted through the first filter area (Y) 142a of the color aperture 142, are made incident on a second G sensor (sub-pixel G_{L}) 158.

The light rays transmitted through the area on the left side (right side seen from the object) of the exit pupil, of the G light rays transmitted through the second filter area (C) 142b of the color aperture 142, are made incident on the first G sensor (sub-pixel G_{R}) 156. The light rays transmitted through the area on the right side (left side seen from the object) of the exit pupil, of the G light rays transmitted through the second filter area (C) 142b of the color aperture 142, are made incident on a second G sensor (sub-pixel G_{L}) 158. The light transmitted through the area on the left side (right side seen from the object) of the exit pupil, of the B light rays transmitted through the second filter area (C) 142b of the color aperture 142, are made incident on a first G sensor (sub-pixel B_{R}) 160. The light rays transmitted through the area on the right side (left side seen from the object) of the exit pupil, of the B light rays transmitted through the second filter area (C) 142b of the color aperture 142, are made incident on a second B sensor (sub-pixel B_{L}) 162.

The first R image signal Ia_{R} from the first R sensor (sub-pixel R_{R}) 152, the second R image signal Ib_{R} from the second R sensor (sub-pixel R_{L}) 154, the first G image signal Ia_{G} from the first G sensor (sub-pixel G_{R}) 156, the second G image signal Ib_{G} from the second G sensor (sub-pixel G_{L}) 158, the first B image signal Ia_{B} from the first R sensor (sub-pixel B_{R}) 160, and the second B image signal Ib_{B} from the second R sensor (sub-pixel B_{L}) 162 are input to a blur corrector 164. The blur corrector 164 supplies the input image signals and the image signals subjected to blur correction to a correlation calculator 166.

Thus, since the color aperture is divided into two parts by the straight line, the first area is Y filter and the second area is C filter, the G light rays are transmitted through the first area (Y) and the second area (C), the R light rays are transmitted through the first area (Y) alone, and B light rays are transmitted through the second area (C) alone. In other words, the G light rays have little influence of optical absorption at the color aperture 142 and the G image of the captured images can be an image which is brighter and has little noise. In addition, since the G light rays are transmitted through both of the areas, the G image is considered as an image having little influence generated by providing the color aperture. For this reason, the G image becomes an image close to an ideal image (called a reference image) captured without the color aperture. Since the R image and the B image are based on the light rays transmitted through only one of the first area and the second area, the blur shape of the R image and the B image changes in accordance with the distance to the object, unlike the reference image (G image).

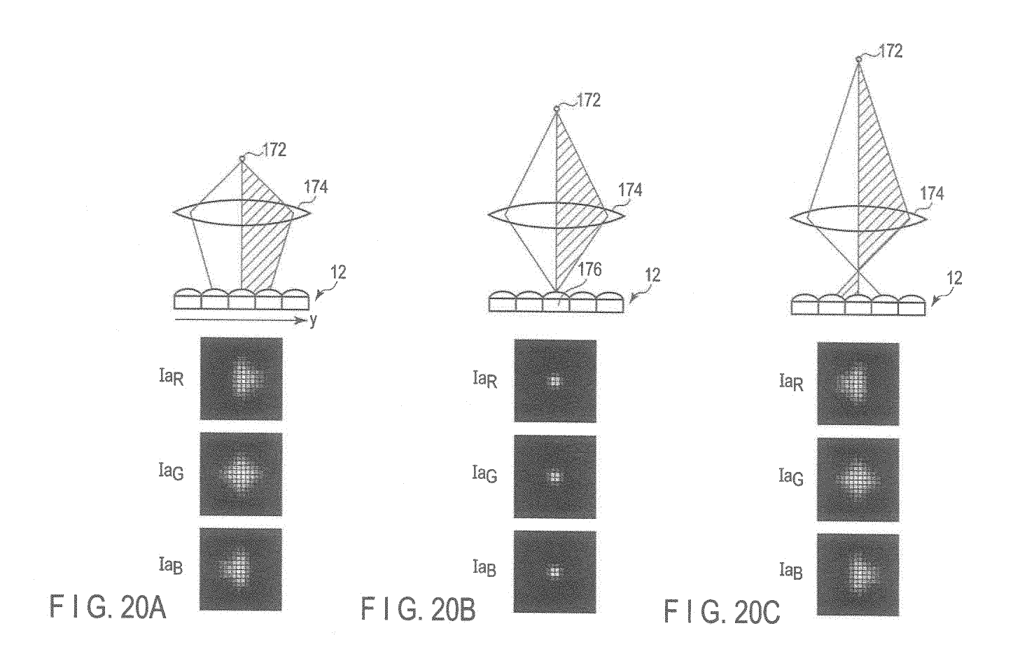

FIGS. 20A, 20B, and 20C show an example of an object's image formation status in the image sensor 12. The lateral direction of FIGS. 20A, 20B, and 20C is a vertical direction (y direction) of FIG. 17. FIG. 20B shows image formation in an in-focus status where the object 172 is located on a focal plane. In this case, since the object image is formed on the imaging surface of the image sensor 12, two light rays transmitted through the first filter area (Y) 142a (hatching area in the drawing) and the second filter area (C) 142b of an imaging lens 174 equipped with a color aperture are made incident on one pixel 176. The blur shapes of the image signals Ia, Ib, and Ia+Ib have an approximately circular shape.

FIG. 20A shows the image formation in a front focus status in which the object 172 is located in front of the focal plane as seen from the image sensor 12. In this case, since the plane on which the object image is formed is located behind the image sensor 12 as seen from the object 172, two light rays transmitted through the first filter area (Y) 142a (hatching area in the drawing) and the second filter area (C) 142b of the imaging lens 174 equipped with the color aperture are made incident on a plurality of pixels different in y-directional position about the pixel 176. The pixel or pixels in which the light rays transmitted through the first filter area (Y) 142a are made incident are located at an upper position (i.e., greater in y value) than the pixels in which the light rays transmitted through the second filter area (C) 142b are made incident.

As explained in the first embodiment, the light rays transmitted through the right side of one filter area and the light rays transmitted through left side of the filter area are made incident on different sub-pixels of the same pixel, respectively. Since the right and left portions of the shape of the blur function of the image output from two sub-pixels are inverted as shown in FIG. 5, the only blur functions of the images output from the first sub-pixels R_{R}, G_{R}, and B_{R} are illustrated in FIGS. 20A, 20B, and 20C for simplification of explanations.

The shape of the blur function of the first R image signal Ia_{R} output from the sub-pixel R_{R} based on the R light rays transmitted through the first filter area (R) 142a is an upper, approximately semicircular shape losing the lower side, and the shape of the blur function of the first B image signal Ia_{B} output from the sub-pixel B_{R} based on the B light rays transmitted through the second filter area (C) 142b is a lower, approximately semicircular shape losing the upper side.

The shape of the blur function of the second R image signal Ib_{R} output from the sub-pixel R_{L} based on the R light rays transmitted through the first filter area (R) 142a is a lower, approximately semicircular shape losing the upper side, and the shape of the blur function of the second B image signal Ib_{B} output from the sub-pixel B_{L} based on the B light rays transmitted through the second filter area (C) 142b is an upper, approximately semicircular shape losing the lower side, though not illustrated in the drawing.

The shape of the blur function of the first G image signal Ia_{G} output from the sub-pixel G_{R} based on the G light rays transmitted through the first filter area (Y) 142a and the second filter area (C) 142b is an approximately circular shape. The shape of the blur function of the second G image signal Ib_{G} output from the sub-pixel G_{L} based on the G light rays transmitted through the first filter area (Y) 142a and the second filter area (C) 142b is also an approximately circular shape, though not illustrated in the drawing.

Similarly, FIG. 20C shows the image formation in a back focus status in which the object 172 is located behind the focal plane as seen from the image sensor 12. In this case, since the plane on which the object image is formed is located in front of the image sensor 12 as seen from the object 172, two light rays transmitted through the first filter area (Y) 142a (hatching area in the drawing) and the second filter area (C) 142b of the imaging lens 174 equipped with a color aperture are made incident on a plurality of pixels different in y-directional position about the pixel 176. The pixel or pixels in which the light rays transmitted through the first filter area (Y) 142a are made incident are located at a lower position (i.e., smaller in y value) than the pixel in which the light rays transmitted through the second filter area (C) 142b are made incident, unlike the front focus status.

The shape of the blur function of the first R image signal Ia_{R} output from the sub-pixel R_{R} based on the R light rays transmitted through the first filter area (R) 142a is a lower, approximately semicircular shape losing the upper side, and the shape of the blur function of the first B image signal Ia_{B} output from the sub-pixel B_{R} based on the B light rays transmitted through the second filter area (C) 142b is an upper, approximately semicircular shape losing the lower side.

The shape of the blur function of the second R image signal Ib_{R} output from the sub-pixel R_{L} based on the R light rays transmitted through the first filter area (Y) 142a is an upper, approximately semicircular shape losing the lower side, and the shape of the blur function of the second B image signal Ib_{B} output from the sub-pixel B_{L} based on the B light rays transmitted through the second filter area (C) 142b is a lower, approximately semicircular shape losing the upper side, though not illustrated in the drawing.

The shape of the blur function of the first G image signal Ia_{G} output from the sub-pixel G_{R} based on the G light rays transmitted through the first filter area (Y) 142a and the second filter area (C) 142b is an approximately circular shape. The shape of the blur function of the second G image signal Ib_{G} output from the sub-pixel G_{L} based on the G light rays transmitted through the first filter area (Y) 142a and the second filter area (C) 142b is also an approximately circular shape, though not illustrated in the drawing.

As shown in FIG. 20A, if the object is located in front of the focal plane as seen from the image sensor 12, the shape of the blur function of the image signal Ia_{G} of the G component is an approximately circular shape located in the center, the blur function of the image signal Ia_{R} of the R component is deviated to the upper side, and the blur function of the image signal Ia_{B} of the B component is deviated to the lower side. As shown in FIG. 20C, if the object is located behind the focal plane as seen from the image sensor 12, the blur function of the image signal Ia_{G} of the G component is an approximately circular shape located in the center, the blur function of the image signal Ia_{R} of the R component is deviated to the lower side, and the blur function of the image signal Ia_{B} of the B component is deviated to the upper side. Thus, the blur functions of the images are different in color and their shapes are varied in accordance the distance to the object.

In the second embodiment, the distance is calculated based on the difference in blur function between the color components of each of two light rays generated by pupil division in the first embodiment. In the second embodiment, the distance is obtained by the DfD method based on the blur functions of the image signals of two color components, of the image signals of three color components. The image signals of two color components for calculating the correlation, of the image signals of three color components, are combined in three manners (R and G; B and G; R and B). The distance may be determined based on the only one of the correlation calculation results but may also be determined by integrating two or three of the correlation calculation results.

Furthermore, the target using the difference in blur function between the color components may be the first image signal Ia output from the first sub-pixels R_{R}, G_{R}, and B_{R}, the second image signal Ib output from the second sub-pixels R_{L}, G_{L}, and B_{L} or the addition signal Ia+Ib of the image signals output from both of the sub-pixels.

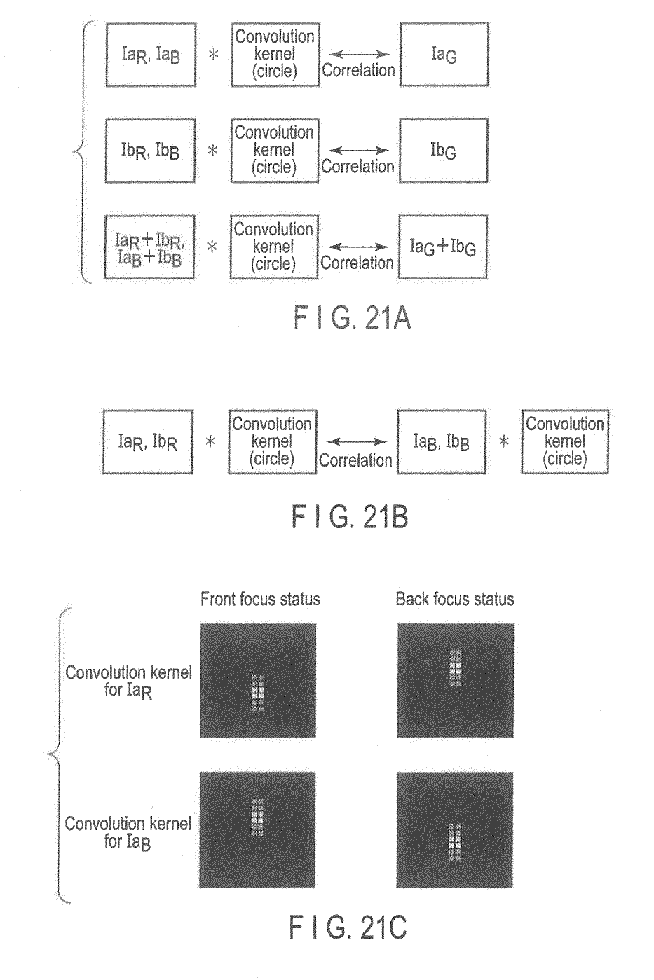

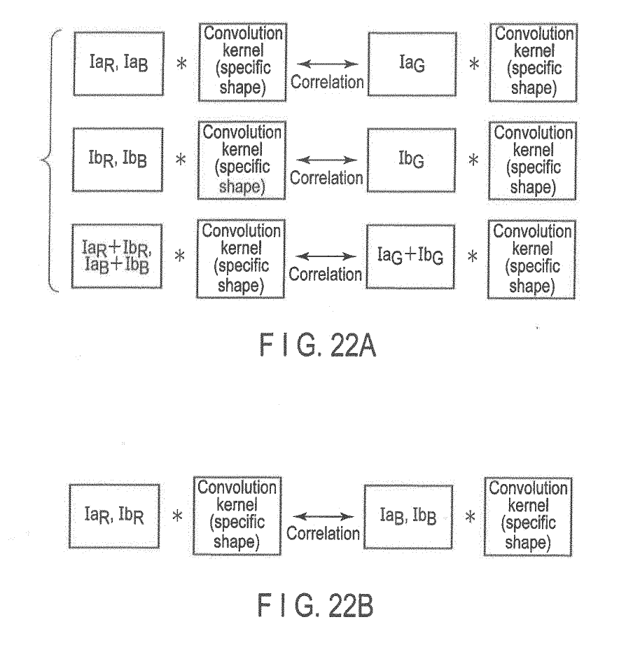

Several examples of the combination of two-color image signals using the difference between the blur functions are shown in FIGS. 21A, 21B, and 21C and FIGS. 22A and 22B.

FIG. 21A shows an example in which the image of the R component, the image of the B component, or the image of the R and B components is used as the target image while the image of the G component is used as the reference image. As regards the output image of the first sub-pixel, the first R image signal Ia_{R}, the first B image signal Ia_{B}, and the addition signal (Ia_{R}+Ia_{B}) are subjected to convolution operation with convolution kernels (see FIG. 21C) which correct the shape of the blur function from an approximately semicircular shape to an approximately circular shape, and corrected image signals Ia_{R}′, Ia_{B}′, and (Ia_{R}′+Ia_{B}′) are obtained.

FIG. 21C shows example of the convolution kernels which correct the approximately semicircular blur function of the image signals Ia_{R} and Ia_{B} of the second embodiment to the approximately circular blur function of the image signal Ia_{G}. The convolution kernels have a component on the y-axis. The filter component is distributed on the lower side if the blur function of the image is deviated to the upper side, and the filter component is distributed on the upper side if the blur function of the image is deviated to the lower side. Correlation between the corrected image signals Ia_{R}′ and Ia_{B}′ and the reference image signal Ia_{G} are calculated.

As regards the output image of the second sub-pixel, the second R image signal Ib_{R} and the second B image signal Ib_{B} are subjected to convolution operation with convolution kernels which correct the shape of the blur function from an approximately semicircular shape to an approximately circular shape, and corrected usage signals Ib_{R}′ and Ib_{B}′ are obtained. Correlation between the corrected image signals Ib_{R}′ and Ib_{B}′ and the reference image signal Ib_{G} are calculated.

As regards the sum of the output image of the first sub-pixel and the output image of the second sub-pixel, the target image signals Ia_{R}+Ib_{R} and Ia_{B}+Ib_{B} are subjected to convolution operation with convolution kernels, and corrected image signals (Ia_{R}+Ib_{R})′ and (Ia_{B}+Ib_{B})′ are obtained. Correlation between the corrected image signals (Ia_{R}+Ib_{R})′ and (Ia_{B}+Ib_{B})′ and the reference image signal (Ia_{G}+Ib_{G}) are calculated.

FIG. 21B shows an example in which the image of the R component or/and the B component is assumed as the target image while the image of the B component or/and the R component is assumed as the reference image. As regards the first sub-pixel, the first R image signal Ia_{R} is subjected to convolution operation with a convolution kernel which corrects the shape of the blur function from an approximately semicircular shape to an approximately circular shape, and a corrected image signal Ia_{R}′ is obtained. The first B image signal Ia_{B} is subjected to convolution operation with a convolution kernel which corrects the shape of the blur function from an approximately semicircular shape to an approximately circular shape, and a corrected image signal Ia_{B}′ is obtained. Correlation between the corrected image signals Ia_{R}′ and Ia_{B}′ is calculated.

As regards the second sub-pixel, the second R image signal Ib_{R} is subjected to convolution operation with a convolution kernel which corrects the shape of the blur function from an approximately semicircular shape to an approximately circular shape, and a corrected image signal Ib_{R}′ is obtained. The second B image signal Ib_{B} is subjected to convolution operation with a convolution kernel which corrects the shape of the blur function from an approximately semicircular shape to an approximately circular shape, and a corrected image signal Ib_{B}′ is obtained. Correlation between the corrected image signals IbR′ and IbB′ is calculated.

FIG. 22A shows an example in which the image of the R component or/and the B component is assumed as the target image and the image of the G component is assumed as the reference image but, unlike FIG. 21A, the shape of the blur function in both of the images is changed to a specific shape. As regards the first sub-pixel, the first R image signal Ia_{R} and the first B image signal Ia_{B} are subjected to convolution operation with convolution kernels which correct the shape of the blur function from an approximately semicircular shape to the specific shape, and corrected image signals Ia_{R}′ and Ia_{B}′ are obtained. The first G image signal Ia_{G} is subjected to convolution operation with a convolution kernel which corrects the shape of the blur function from an approximately semicircular shape to the specific shape, and a corrected reference image signal IaG′ is obtained. Correlation between the corrected image signals Ia_{R}′ and Ia_{B}′ and the reference image signal Ia_{G}′ are calculated.

As regards the second sub-pixel, the second R image signal Ib_{R} and the second B image signal Ib_{B} are subjected to convolution operation with a convolution kernel which corrects the shape of the blur function from an approximately semicircular shape to the specific shape, and corrected target image signals Ib_{R}′ and Ib_{B}′ are obtained. The second G image signal Ib_{G} is subjected to convolution operation with a convolution kernel which corrects the shape of the blur function from an approximately circular shape to the specific shape, and a corrected reference image signal Ib_{G}′ is obtained. Correlation between the corrected image signals Ib_{R}′ and Ib_{B}′ and the reference image signal Ib_{G}′ are calculated.

As regards the sum of the output image of the first sub-pixel and the output image of the second sub-pixel, the target image signals (Ia_{R}+Ib_{R}) and (Ia_{B}+Ib_{B}) are subjected to convolution operation with a convolution kernels which corrects the shape of the blur function to the specific shape, and corrected image signals (Ia_{R}+Ib_{R})′ and (Ia_{B}+Ib_{B})′ are obtained. The reference image signal (Ia_{G}+Ib_{G}) is subjected to convolution operation with a convolution kernel which corrects the shape of the blur function to the specific shape, and a corrected reference image signal (Ia_{G}+Ib_{G})′ is obtained. Correlation between the corrected target image signals (Ia_{R}+Ib_{R})′ and (Ia_{B}+Ib_{B})′ and the corrected reference image signal (Ia_{G}+Ib_{G})′ is calculated.

FIG. 22B shows an example in which the image of the R component or/and the B component is assumed as the target image and the image of the B component or/and the R component is assumed as the reference image but, unlike FIG. 21B, the shape of the blur function in both of the images is changed to a specific shape. As regards the first sub-pixel, the first R image signal Ia_{R} is subjected to convolution operation with a convolution kernel which corrects the shape of the blur function from an approximately semicircular shape to the specific shape, and a corrected image signal Ia_{R}′ is obtained. The first B image signal Ia_{B} is subjected to convolution operation with a convolution kernel which corrects the shape of the blur function from an approximately semicircular shape to the specific shape, and a corrected image signal Ia_{B}′ is obtained. Correlation between the corrected image signals Ia_{R}′ and Ia_{B}′ is calculated.

As regards the second sub-pixel, the second R image signal Ib_{R} is subjected to convolution operation with a convolution kernel which corrects the shape of the blur function from an approximately semicircular shape to the specific shape, and a corrected image signal Ib_{R}′ is obtained. The second B image signal Ib_{B} is subjected to convolution operation with a convolution kernel which corrects the shape of the blur function from an approximately semicircular shape to the specific shape, and a corrected image signal Ib_{B}′ is obtained. Correlation between the corrected image signals Ib_{R}′ and Ib_{B}′ is calculated.

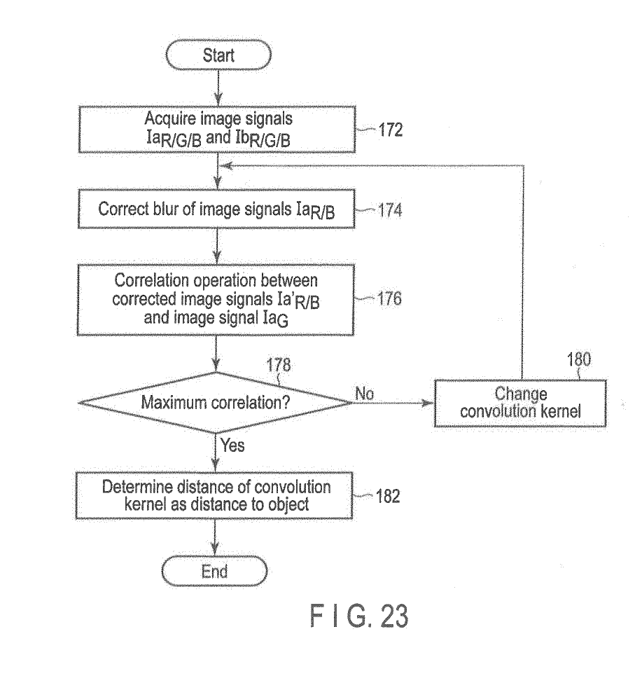

FIG. 23 is a flowchart showing a flow of the distance calculation according to the second embodiment. In block 172, the blur corrector 164 inputs the image signals Ia_{R/G/B} and Ib_{R/G/B} output from two photodiodes 54a and 54b of each pixel of the image sensor 12. The types of the correlation operation are the same as those shown in FIG. 21A. For this reason, in block 174, the blur corrector 164 assumes the distance as a certain distance d1, and executes convolution operation of the image signal Ia_{R/B} (or Ib_{R/B}) with the convolution kernel corresponding to the assumed distance d1 in the convolution kernel group for correcting the shape of the blur function to the approximately circular shape. In block 176, the correlation calculator 166 calculates correlation between the corrected image signals Ia_{R/B}′ (or Ib_{R/B}′) and the reference image signal Ia_{G} (or Ib_{G}) for each pixel by SSD, SAD, NCC, ZNCC, Color Alignment Measure, and the like as shown in FIG. 21A.

In block 178, the correlation calculator 166 determines whether the maximum value of the correlation has been detected or not. If the maximum value is not detected, the correlation calculator 166 instructs the blur corrector 164 to change the convolution kernel. The blur corrector 164 selects a convolution kernel corresponding to another distance d1+α from the convolution kernel group, in block 180, and executes convolution operation of both the image signal Ia_{R/B} (or Ib_{R/B}) and the selected convolution kernel, in block 174.

If the maximum value of correlation for each pixel is detected in block 178, the correlation calculator 166 determines the distance corresponding to the convolution kernel which makes the correlation maximum as the distance to the object, in block 182.

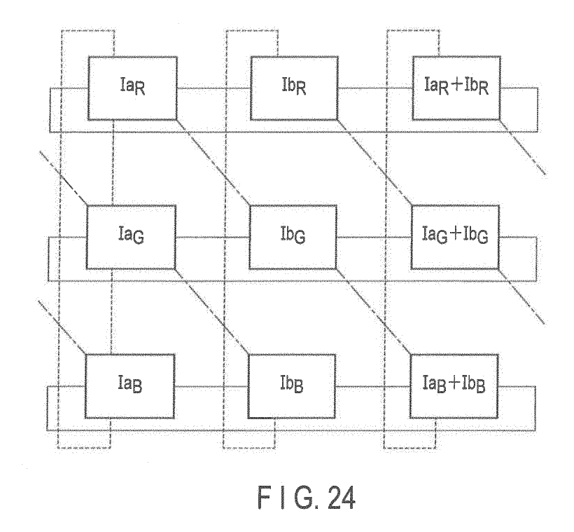

In FIG. 23, the distance is calculated based on the result of comparison in shape of the blur function between the color components of one of two light beams generated by the pupil division in the first embodiment. The images generated in the second embodiment are illustrated in FIG. 24. Images of the same row connected by solid lines in FIG. 24, for example, Ia_{R}, Ib_{R}, and Ia_{R}+Ib_{R} are images having the same color (R) and output from the sub-pixels R_{R} and R_{L} in which the light rays transmitted through the different areas in exit pupil are made incident. In the first embodiment, correlation between at least two images of three images in the same row in FIG. 24 is calculated. Images of the same column connected by broken lines in FIG. 24, for example, Ia_{R}, Ia_{G}, and Ia_{B} are images having different colors and output from the sub-pixel R_{R} in which the light rays transmitted through the area having the same exit pupils are made incident. In the second embodiment, correlation between at least two images of three images in the same column in FIG. 24 is calculated.

In the blur correction, the convolution kernel is subjected to convolution operation on the images. Since elements of the convolution kernel are distributed one-dimensionally on an axis of a direction opposite to the direction of deviation of the blur function, the correction may not be able to be obtained if the direction of the edge included in the object matches the direction of deviation of the blur function. For example, if the convolution kernel is a one-dimensional filter arranged along the x-axis similarly to the first embodiment, the convolution operation result of a horizontal edge and the convolution kernel is the same in any distance, and the distance cannot be obtained. In addition, if the convolution kernel is a one-dimensional filter arranged along the y-axis similarly to the second embodiment, the convolution operation result of a vertical edge and the convolution kernel is the same in any distance, and the distance cannot be obtained.

In the second embodiment, however, since six images Ia_{R}, Ib_{R}, Ia_{G}, Ib_{G}, Ia_{B}, and Ia_{B} are generated as shown in FIG. 19, the distance can be obtained by calculating the correlation defined the first embodiment and correlation defined in the second embodiment even if the object includes the horizontal edge or the vertical edge. The first distance obtained by the correction in the first embodiment and the second distance obtained by the correction in the second embodiment may be averaged.

In the second embodiment, the correlation of the image signals of different colors in the first or second sub-pixels is calculated as represented by the broken lines in FIG. 24, but the correlation of the image of the first color of the first sub-pixel, for example, Ia_{R}, the image of the second color of the second sub-pixel, for example, Ib_{G}, and the addition signal of the image of the third color of the first sub-pixel and the image of the third color of the second sub-pixel, for example, Ia_{B}+Ib_{B}, may be calculated as represented by one-dot chain lines in FIG. 24.

In the second embodiment, an example of providing one color aperture including two color areas of yellow and cyan is described. The color aperture may include a plurality of color areas and the color areas may correspond to a plurality of pixels, respectively. Alternatively, each of a plurality of color areas of the color aperture may correspond to a plurality of pixels. For example, one color area can be provided for four pixels, nine pixels or sixteen pixels.

### Application Example of Distance Information

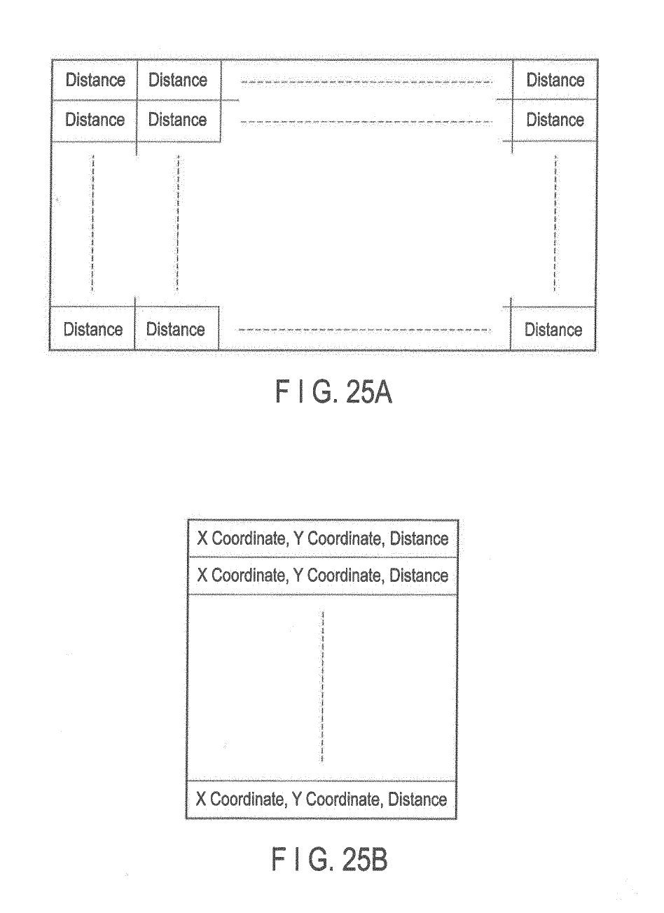

The display of the depth map is explained as the mode of outputting the distance information in the above-described embodiments, but the outputting mode is not limited to this and may be display of a table of correspondence between the distance and the position as shown in FIG. 25A. FIG. 25A shows an example of two-dimensionally displaying distance information corresponding to each coordinate of an image as a numerical value. FIG. 25B shows an example of displaying the correspondence between each coordinate of an image and the distance information (numerical value) as a table. Output of the distance information is not limited to display but may be printing. In the depth map or the display example shown in FIG. 25A or 25B, the distance information may not be obtained for all the pixels, but the distance information may be obtained for every block of several pixels or several tens of pixels. Furthermore, the distance information may not be obtained for the entire screen, and several objects in the screen alone may be used as the target for distance detection. Specifying the target for distance detection can be executed by, for example, image recognition or designation made by user input.

In addition to the distance to the object of each pixel, a maximum value, a minimum value, a central value, an average and the like of the distance of the object in the whole screen may be output. Furthermore, not only the depth map of the whole screen, but an area division result of dividing the screen in accordance with the distance may be output.

When the depth map is displayed, a signal to display a depth map image may be supplied from the CPU 22 to the display 30 or an image signal to display an RGB image and a signal to indicate the distance may be supplied from the CPU 22 to the display 30.

Furthermore, when the embodiments are applied to an image recorder, the distance information may be used as attribute information corresponding to a recorded image. For example, attribute information (index) is added to at least one image corresponding to a scene in which the object exists in front of a plane of a certain distance. Thus, since a user replays the only scene to which attribute information is added and can skip the other scenes when watching a plurality of recorded images or video including a plurality of images, the user can efficiently watch the only scene in which the event happens. On the contrary, the user can also efficiently watch the only scene in which the events do not happen by replaying the only scene in which attribute information is not generated.

The following information can be acquired by processing the blur function of the image signal of each pixel by using the distance information. An all-focus image in which the image signals of all the pixels are a focusing status can be generated. A refocused image in which an object area different from that at the time of capturing becomes in a focusing status and an object area which has been a focusing status at the time of capturing becomes an unfocused status can be generated. The embodiment can extract an object at an arbitrary distance or recognize the extracted object. Furthermore, the object's behavior can also be estimated by following the variation of the distance of the recognized object.

In the embodiments, the distance information is displayed such that the user can recognize the distance information on the image data processor, but is not limited to this, and the distance information may be output to another device and used in the other device. According to the embodiments, the captured image and the distance information can be acquired by using not a stereo camera, but a single-lens camera, and a small lightweight single-lens camera can be applied in various fields.

One of examples of application of the camera according to the embodiments is a mobile body such as a vehicle, a drone, a mobile robot (Automated Guided Vehicle), a vacuum cleaner robot called a self-travelling cleaner, a communication robot providing various types of guidance to visitors in an event site, and the like, or an industrial robot including arms. The mobile body monitors a surrounding situation and controls movement in accordance with the situation. For example, as regards a vehicle in recent years, cameras have been mounted on the entire surrounding of a vehicle body to monitor a surrounding situation. To monitor the surrounding situation, a distance to an object in the surrounding needs to be recognized. Since cameras for side view mirrors and a camera for back monitor need to be downsized and single-lens cameras are predominant, the distance to the object cannot be measured by conventional single-lens cameras. According to the embodiments, however, the distance to the object can be correctly measured with a single-lens camera. Automatic drive can also be implemented. The automatic drive implies not only autonomous driving, but also operation includes not only driver assistance such as lane keeping, cruise control, and automatic brake. In addition, recently, visual inspection of bridges using drones, and the like has been executed and drones have used to check infrastructure check. Delivery of parcels using drones has also been considered. A drone is generally equipped with a GPS and can be easily controlled to the destination but, to cope with an unexpected obstruction, monitoring the situation around a drone has been desired. A mobile robot and a cleaner robot are also considered to require the same obstruction avoidance function. A movable body is not limited to the above-explained examples but may include a drive mechanism for traveling and can be implemented as vehicles including cars, flying objects such as drones and airplanes, vessels, and various bodies. The mobile body implies not only robots including mobile bodies, but industrial robots including a drive mechanism for movement and rotation of a part of a robot such as a robot arm.

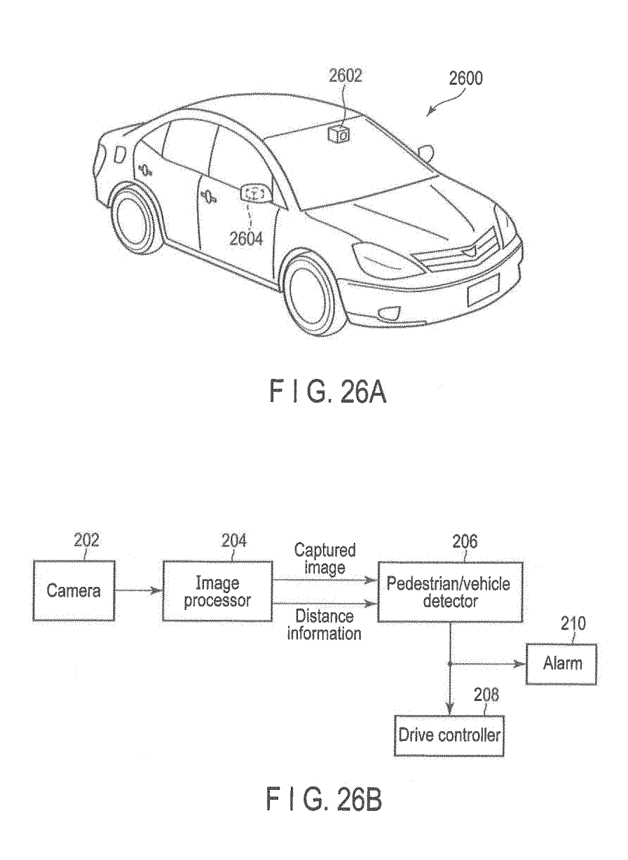

FIGS. 26A and 26B show an example of a system configuration where the embodiments are applied to a vehicle. As shown in FIG. 26A, a front camera 2602 which is a camera of the embodiments is attached to an upper part of a windshield in front of a driver's seat of a car 2600, to capture an image ahead the driver's seat. The cameras is not limited to the front camera 2602, but may be a side camera 2604 which is attached to a side view mirror to capture a back side. Furthermore, the camera may be a rear camera attached to a rear windshield, though not illustrated in the drawing. In recent years, a drive recorder which records a front view of the car captured with a camera attached to the windshield of the car on an SD (Secure Digital) card, or the like has been developed. Not only the images captured in front of the car, but the distance information can be acquired by applying the camera of the embodiments to the camera of the drive recorder, without providing a camera inside the car separately.

FIG. 26B is a block diagram showing an example of s vehicle driving control system. The output of the camera 202 (front camera 2602, side camera 2604, or the rear camera) is input to an image processor 204 of the first or second embodiment. The image processor 204 outputs the captured image and the distance information for each pixel. The captured image and the distance information are input to a pedestrian/vehicle detector 206. The pedestrian/vehicles detector 206 sets an object perpendicular to a road as a target area of a pedestrian/vehicle in the captured image, based on the captured image and the distance information. The pedestrian/vehicle detector 206 can detect a pedestrian/vehicle by calculating the feature quantity for each target area, and comparing this feature quantity with a number of reference data elements preliminarily obtained from a large number of sample image data elements. If the pedestrian/vehicle is detected, the alarm 210 may be emitted to the driver or a drive controller 208 is activated and the driving is controlled for avoidance of collision and the like. The drive control implies deceleration and stop executed by an automatic brake, steering control, and the like. A detector which detects a specific object may be used instead of the pedestrian/vehicle detector 206. The side camera and the rear camera may detect an obstruction found when the car is reversed for parking a car instead of detecting the pedestrian/vehicle. In addition, the drive control can imply driving a safety device such as an air bag. The drive controller 208 may control the driving such that the distance to a vehicle in front of the camera 202 is constant.

If the embodiments are applied to the drive recorder, at least one of the start and stop of recording images, change of resolution, and change of a compression rate may be executed based on whether the distance to the object is shorter or longer than the reference distance. Thus, for example, recording the images can be started, the resolution can be increased and the compression rate can be reduced at the time immediately before an accident at which an object has approached within a reference distance. Furthermore, if this technology is applied to the monitoring camera installed in the house and the like, recording the images can be started, the resolution can be increased and the compression rate can be reduced at the time when a person approaches within a reference distance. On the contrary, if the object moves away to the back side, recording the images can be stopped, the resolution can be lowered, or the compression rate can be increased. Furthermore, if the embodiments are applied to a flying object such as a drone to capture the ground surface from the sky, the resolution can be increased and the compression rate can be lowered such that fine parts of the object located at a remote position can be observed.

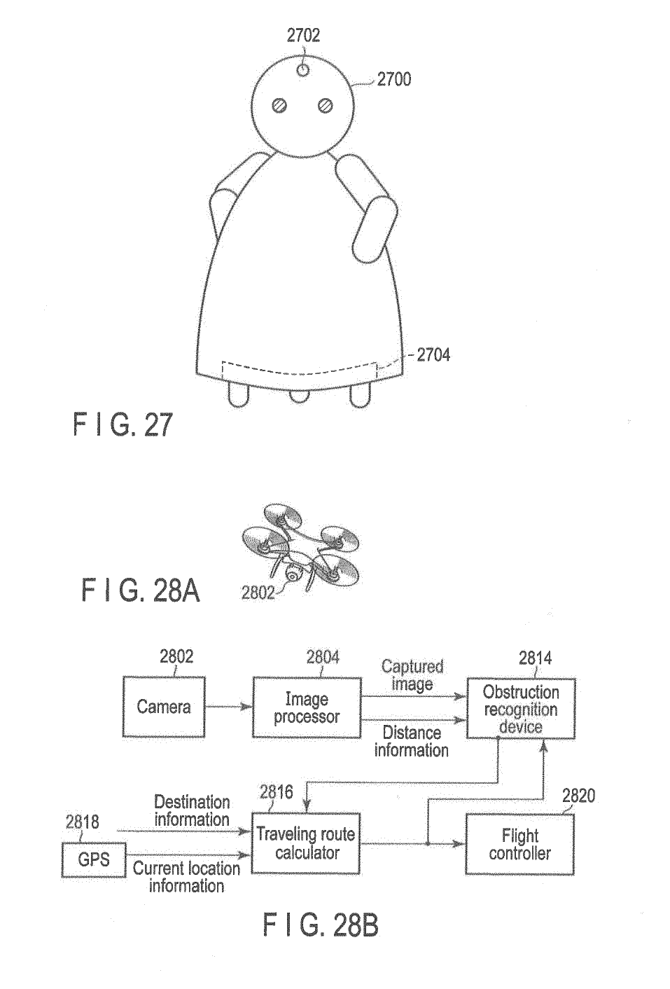

FIG. 27 shows an example of a robot 2700 capable of automatically moving, such as AGV, a cleaner robot, a communication robot, or the like to which the camera of the embodiments is applied. The robot 2700 includes a camera 2702 and a drive mechanism 2704. The camera 2702 is configured to capture an object in a traveling direction or moving direction of the robot 2700 or its part (an arm or the like). As a mode of capturing the object in the traveling direction and the moving direction, the camera can be mounted as what is called a front camera capable of capturing the front side or what is called a rear camera capable of capturing the back side at the time of reversing. Of course, both of the cameras may be mounted. In addition, the camera 2702 may include a function of a drive recorder for a vehicle together. If the movement and rotation of a part such as an arm, of the robot 2700, are controlled, the camera 2702 may be installed at a tip of the robot arm so as to capture, for example, an object held by the robot arm.

The drive mechanism 2704 executes acceleration, deceleration, and avoidance of collision, turn, operation of a safety device or the like of the robot 2700 or its part, based on the distance information.

An example of traveling control of the drone which can avoid an obstruction is shown in FIGS. 28A and 28B. As shown in FIG. 28A, a camera 2802 of the embodiments is attached to the drone. As shown in FIG. 28B, an output of the camera 2802 is input to an image processor 2804 of the embodiments. The captured image and the distance information for each pixel which are output from the image processor 2804 are input to an obstruction recognition device 2814. The traveling route of a drone is automatically determined if a destination and a current location are recognized. The drone includes a GPS (Global Positioning System) 2818, and the destination information and the current location information are input to a traveling route calculator 2816. The traveling route information output from the traveling route calculator 2816 is input to the obstruction recognition device 2814 and a flight controller 2820. The flight controller 2820 executes adjustment of steering, acceleration, deceleration, thrust, lift, and the like.

The obstruction recognition device 2814 extracts the object within a certain distance from the drone, based on the captured image and the distance information. A detection result is supplied to the travelling route calculator 2816. If the obstruction is detected, the traveling route calculator 2816 corrects the traveling route determined based on the destination and the current location to a traveling route of a smooth orbit which can avoid the obstruction.

Thus, even if an unexpected obstruction appears in air, the system enables the drone to safely fly to the destination while automatically avoiding the obstruction. The system of FIG. 28B can also be applied to not only the drone, but a mobile robot (Automated Guided Vehicle), a cleaner robot, and the like having its traveling route determined. As regards the cleaner robot, the route itself is not determined but, rules of turning, moving backwards and the like if an obstruction is detected are often determined. Even in this case, too, the system of FIG. 28B can be applied to the detection and avoidance of the obstruction.

A drone for checking a crack on a road or a structure, breakage of an electric wire, and the like from sky may be controlled to obtain a distance to an object for check from the captured image which shows the object for check and to fly while maintaining a certain distance to the object for check. Furthermore, the camera may capture not only the object for check but the ground surface may be captured by the camera and flight of the drone may be controlled to maintain a designated height from the ground surface. Maintaining a certain distance from the ground surface has an effect that a drone for spraying agricultural chemicals can uniformly spray the agricultural chemicals.

Next, an example of installing the camera on a stationary object will be explained. A typical example is a monitoring system. The monitoring system detects entry of an object into a space captured by a camera, and executes operations, for example, emitting an alarm and opening a door.

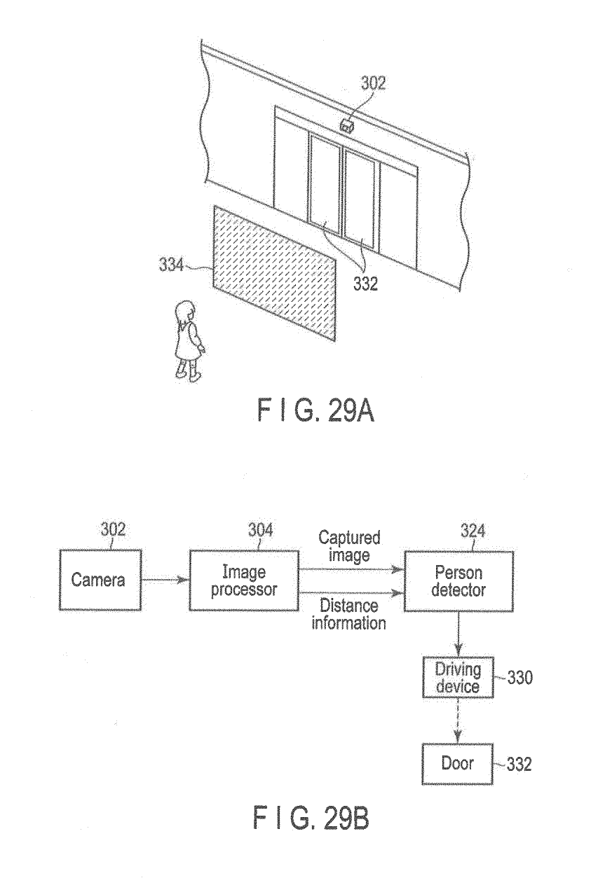

FIG. 29A shows an example of an automatic door system. The automatic door system includes a camera 302 attached to an upper part of a door 332. The camera 203 is provided at a position at which the camera can capture a pedestrian and the like moving in front of the door 332, and installed to capture an image which enables a passage in front of the door 332, and the like to be viewed. The automatic door system sets a reference plane 334 in front of the door 332, determines whether a pedestrian or the like exists in front of the reference plane 334 or behind the reference plane 334, based on the distance information to the pedestrian, and opens and closes the door 332 based on a determination result. The reference plane 334 may be a plane (plane parallel to the door 332) at a certain distance from the door 332 or a plane (plane unparallel to the door 332) at a certain distance from the camera 302. Furthermore, the reference plane may be not only the plane but a curved surface (for example, a part of a column about the line of center of the door).

As shown in FIG. 29B, an output of the camera 302 of the embodiments is input to the image processor 304 of the embodiments. The captured image and the distance information for each pixel output from the image processor 304 are input to the person detector 324. The person detector 324 controls a driving device 330 to open the door 332 if the person detector 324 detects a pedestrian or the like moving from the back of the reference plane 334 to the front of the reference plane 334, and controls the driving device 330 to close the (opened) door if the person detector 324 detects a pedestrian or the like moving from the front of the reference plane 334 to the back of the reference plane 334. The driving device 330 includes, for example, a motor and opens and closes the door 332 by transmitting the drive of the motor to the door 332.

The structure of such an automatic door system can also be applied to control of a vehicle door. For example, the camera is built in a doorknob and, if a person approaches the door, the door is opened. In this case, the door may be a sliding door. Alternatively, if a person is very close to the door, the door is controlled not to be opened even if a passenger executes an operation to open the door. According to this automatic door system, when a person stays near the door, an accident of contact between the door and the person caused by the opening door can be prevented.

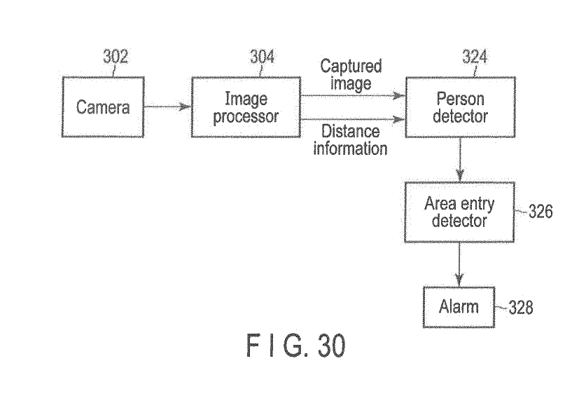

FIG. 30 shows an example of a monitoring system. Arrangement of a camera may be the same as that in FIG. 29A. The output of the camera 302 of the embodiments is input to the image processor 304 of the embodiment. The captured image and the distance information for each pixel output from the image processor 304 are input to the person detector 324. The person detector 324 detects a person similarly to the pedestrian/vehicle detector 206. A detection result is supplied to an area invasion detector 326. An area entry detector 326 determines whether or not a person has entered a specific area within a predetermined range from the camera 302, based on the distance to the detected person. If a person's entry is detected an alarm 328 is emitted.

The monitoring system is not limited to a system for detection of entry but may be, for example, a system for recognizing flow of persons, vehicles and the like in a store or a parking lot for each time zone.

The system can also be applied to, for example, a manufacturing robot which is not a movable body but stationary and which includes a movable member, and the like. If an obstruction is detected in accordance with the distance from the arm holding and moving a component and processing a component, movement of the arm may be limited.

Since the processing of the present embodiment can be implemented by the computer program, advantages similar to those of the present embodiment can easily be obtained by loading the computer program into a computer via a computer-readable storage medium on which the computer program is stored, and by merely executing the computer program.

The present invention is not limited to the embodiments described above, and the constituent elements of the invention can be modified in various ways without departing from the spirit and scope of the invention. Various aspects of the invention can also be extracted from any appropriate combination of constituent elements disclosed in the embodiments. For example, some of the constituent elements disclosed in the embodiments may be deleted. Furthermore, the constituent elements described in different embodiments may be arbitrarily combined.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An imaging device comprising:
a first optical system configured to perform first image blurring and second image blurring to light from an object;
an image capturing device configured to receive the light from the object through the first optical system and output a first image signal including first blur and a second image signal including second blur; and
a data processor configured to generate distance information based on the first image signal and the second image signal.

2. The imaging device of claim 1, wherein
the data processor is configured to
correct the first image signal in order to change a shape of the first blur to a third shape different from the shape of the first blur and a shape of the second blur, and
generate the distance information based on correlation between the second image signal and the corrected first image signal.

3. The imaging device of claim 1, wherein
the first blur has a first shape,
the second blur has a second shape,
an addition image signal of the first image signal and the second image signal includes third blur having a third shape, and
the data processor is configured to
correct the first image signal such that the first shape matches the third shape, and
generate the distance information based on correlation between the corrected first image signal and the addition image signal.

4. The imaging device of claim 1, wherein
the first blur has a first shape,
the second blur has a second shape, and
the data processor is configured to
correct the first image signal such that the first shape matches a third shape different from the first shape and the second shape,
correct the second image signal such that the second shape matches the third shape, and
generate the distance information based on correlation between the corrected first image signal and the corrected second image signal.

5. The imaging device of claim 1, wherein
the image capturing device comprises pixels and color filter elements corresponding to the pixels,
the pixels comprises first pixels each outputting the first image signal, and
the first pixels correspond to the color filter elements of the same color.

6. The imaging device of claim 1, wherein
the image capturing device comprises pixels, each of the pixels comprising two sub-pixels,
the first optical system comprises micro-lenses corresponding to the pixels.

7. The imaging device of claim 6, wherein
the shape of the first blur varies in accordance with a distance to an object, and
the data processor is configured to correct the first image signal by using convolution kernels that are set in relation to distances to an object, and that change the shape of the first blur to a shape of reference blur and in which degree of the change corresponds to the distances to the object, and generate the distance information based on correlation between the corrected first image signal and a reference image signal including the reference blur.

8. The imaging device of claim 7, wherein
the shape of the reference blur matches a shape of a diaphragm of the first optical system.

9. The imaging device of claim 1, wherein
the image capturing device comprises pixels,
the pixels comprises a first pixel outputting the first image signal and a second pixel outputting the second image signal,
the first optical system comprises a first light shield shielding a first portion of the first pixel from light and a second light shield shielding a second portion of the second pixel from light, and
the first portion is different from the second portion.

10. The imaging device of claim 9, wherein
the shape of the first blur varies in accordance with a distance to an object, and
the data processor is configured to correct the first image signal by using convolution kernels that are set in relation to distances to an object, and that change the shape of the first blur to a shape of reference blur and in which degree of the change corresponds to the distances to the object, and generate the distance information based on correlation between the corrected first image signal and a reference image signal including the reference blur.

11. The imaging device of claim 10, wherein
the shape of the reference blur matches a shape of a diaphragm of the first optical system.

12. The imaging device of claim 1, wherein
the first optical system comprises a polarization plate having a first area of a first polarization axis and a second area of a second polarization axis, and
the first polarization axis is orthogonal to the second polarization axis.

13. The imaging device of claim 12, wherein
the shape of the first blur varies in accordance with a distance to an object, and
the data processor is configured to correct the first image signal by using convolution kernels that are set in relation to distances to an object, and that change the shape of the first blur to a shape of reference blur and in which degree of the change corresponds to the distances to the object, and generate the distance information based on correlation between the corrected first image signal and a reference image signal including the reference blur.

14. The imaging device of claim 13, wherein
the shape of the reference blur matches a shape of a diaphragm of the first optical system.

15. The imaging device of claim 1, wherein
the image capturing device comprises pixels and color filter elements corresponding to the pixels,
the pixels comprises a first pixel outputting the first image signal and a second pixel outputting the second image signal, and
the first pixel corresponds to a color filter element of a first color and the second pixel corresponds to a color filter element of the first color.

16. The imaging device of claim 1, wherein
the data processor is further configured to generate a depth map, a table indicative of a distance to an object for each pixel, an all-focus image, a re-focus image, or area division image, based on the distance information.

17. The imaging device of claim 1, wherein
the data processor is further configured to calculate a maximum distance, a minimum distance, a center distance, or an average distance of an image, based on the distance information.

18. The imaging device of claim 1, further comprising:
a second optical system configured to perform third image blurring to a first color component of the light from the object and fourth image blurring to a second color component of the light from the object, and wherein
the image capturing device is configured to receive the light from the object through the first optical system and the second optical system and output a third image signal including third blur and a fourth image signal including fourth blur; and
the data processor is further configured to generate second distance information based on the third image signal and the fourth image signal.

19. The imaging device of claim 18, wherein
the second optical system comprises color filter elements of yellow and cyan, or color filter elements of magenta and cyan.

20. An automatic control system, comprising:
the imaging device of claim 1; and
a controller configured to perform control processing, based on the distance information generated by the imaging device.
